(19) United States
(12) Patent Application Publication
(10) Pub. No.: US 2010/0037526 A1
(43) Pub. Date: Feb. 18, 2010

(54) NATURAL VENTILATION WINDOW

(76) Inventors: Mamoru Ohishi, Tokyo (JP); Kenji Nakamata, Tokyo (JP)

Correspondence Address: NIXON & VANDERHYE, PC, 901 NORTH GLEBE ROAD, 11TH FLOOR, ARLINGTON, VA, 22203, US

(21) Appl. No.: 12/441,612

(22) PCT Filed: Sep. 6, 2007
(86) PCT No.: PCT/JP2007/000967

§ 371 Date: Mar. 30, 2009

(30) Foreign Application Priority Data
Sep. 20, 2006 (JP) 2006-254115
Jan. 24, 2007 (JP) 2007-014184
Feb. 8, 2007 (JP) 2007-028976

(51) Int. Cl. E05F 11/00

(52) U.S. Cl. 49/326

(57) ABSTRACT

A natural ventilation window 1 includes: a framed panel 2 and an opening/closing means 5 for causing the framed panel 2 to open and close an opening portion 4 of a building on the basis of an air current 3. The opening/closing means 5 includes a supporting mechanism 32 for supporting a portion 31 on a top rail 22 side of the framed panel 2 liftably and rotatably about a horizontal axis S1 in an R1 direction; a supporting mechanism 34 for supporting a portion 33 of the framed panel 2, which is located below the portion 31, movably in a direction A toward the interior or exterior of the building and rotatably about a horizontal axis S2 in an R2 direction; and an engaging member 35 for causing the framed panel 2 to engage a window frame 11 defining the opening portion 4, so as to maintain a state of the opening portion fully closed by the framed panel 2.

### TECHNICAL FIELD

The present invention relates to a natural ventilation window for opening and closing an opening portion of a building by the opening and closing movement of a framed panel based on an air current.

### BACKGROUND ART

[Patent Document 1] JP-A-2003-247371

A proposal has been made in patent document 1, for example, for a natural ventilation window which is comprised of a main arm having one end pivotally secured to an upper portion of a stile of a framed panel and another end pivotally secured to a vertical frame of a window frame at a position lower than the one end, as well as a sub arm having one end pivotally secured to an intermediate portion of the stile and another end pivotally secured to a lower portion of the vertical frame, the sub arm being longer than the main arm. The one end of the sub arm and the center of gravity of the framed panel with the window closed are respectively disposed so as to be located on an identical line extending in a vertical direction.

### DISCLOSURE OF THE INVENTION

### Problems that the Invention is to Solve

In such a natural ventilation window, in the light of relationships involving such as the rotation of the main arm and the sub arm and the respective positions of the one end of the sub arm and the center of gravity of the framed panel, the rotational moment toward a fully-open position of the opening portion of the building, which is imparted to the framed panel, increases when the window is opened. Therefore, it is difficult to lighten the opening portion closing movement, based on the air current, of the framed panel on the opening portion fully-open position side and to make heavy the opening portion closing movement, based on the air current, of the framed panel on an opening portion fully-closed position side.

In addition, in such the natural ventilation window, in the light of relationships involving such as the rotation of the main arm and the sub arm and the respective positions of the one end of the sub arm and the center of gravity of the framed panel, the rotational moment toward an open position of the opening portion of the building, which is imparted to the framed panel, increases when the window is opened. Therefore, it is difficult to lighten the opening portion closing movement, based on the air current, of the framed panel on an opening portion open position side and to make heavy the opening portion closing movement, based on the air current, of the framed panel on an opening portion closed position side. In addition, with such a natural ventilation window, it is desirable to prevent rapid opening portion opening movement of the framed panel on the opening portion open position side and rapid opening portion closing movement of the framed panel on the opening portion closed position side.

Furthermore, in such the natural ventilation window, in the light of relationships involving such as the rotation of the main arm and the sub arm and the respective positions of the one end of the sub arm and the center of gravity of the framed panel, the rotational moment toward the open position of the opening portion of the building, which is imparted to the framed panel, increases when the window is opened. Therefore, it is difficult to lighten the opening portion closing movement, based on the air current, of the framed panel on the opening portion open position side and to make heavy the opening portion closing movement, based on the air current, of the framed panel on the opening portion closed position side. Further, a natural ventilation window is desirable in which nothing is made to project on both the building interior side and the building exterior side when the framed panel is in the opening portion closed position.

The present invention has been devised in view of the above-described aspects, and its object is to provide a natural ventilation window which makes it possible to lighten the opening portion closing movement, based on the air current, of the framed panel on the opening portion fully-open position side and to make heavy the opening portion closing movement, based on the air current, of the framed panel on the opening portion fully-closed position side, thereby making it possible to suitably provide ventilation by the opening/closing movement, based on the air current, of the framed panel on the opening portion fully-open position side and to prevent the rapid opening/closing movement of the framed panel on the opening portion fully-closed position side.

Another object of the invention is to provide a natural ventilation window which makes it possible to lighten the opening portion closing movement, based on the air current, of the framed panel on the opening portion open position side and to make heavy the opening portion closing movement, based on the air current, of the framed panel on the opening portion closed position side, thereby making it possible to suitably provide ventilation by the opening/closing movement, based on the air current, of the framed panel on the opening portion open position side and to prevent the rapid opening portion opening movement of the framed panel on the opening portion open position side and the rapid opening portion closing movement of the framed panel on the opening portion closed position side.

Still another object of the invention is to provide a natural ventilation window which makes it possible to lighten the opening portion closing movement, based on the air current, of the framed panel on the opening portion open position side and to make heavy the opening portion closing movement, based on the air current, of the framed panel on the opening portion closed position side, thereby making it possible to suitably provide ventilation by the opening/closing movement, based on the air current, of the framed panel on the opening portion open position side, and in which nothing is made to project on both the building interior side and the building exterior side when the framed panel is in the opening portion closed position.

### Means for Solving the Problems

In accordance with the present invention, a natural ventilation window comprises: a framed panel; and opening/closing means for causing the framed panel to open and close an opening portion of a building on the basis of an air current, wherein the opening/closing means includes a first supporting mechanism for supporting a portion on one side of either a top rail or a bottom rail of the framed panel liftably and rotatably about a horizontal axis and a second supporting mechanism for supporting another portion of the framed panel located below or above the portion, movably in a direction toward an interior or exterior of the building and rotatably about the horizontal axis, the another portion being disposed so as to be located above a center of gravity of the framed panel in an opening portion fully-closed position and to be located on one side of either the building interior or the building exterior with respect to the center of gravity.

According to the natural ventilation window in accordance with the invention, the other portion of the framed panel, in particular, is disposed so as to be located above the center of gravity of the framed panel in the opening portion fully-closed position and to be located on one side of either the building interior or the building exterior with respect to that center of gravity. Therefore, it is possible to lighten the opening portion closing movement, based on the air current, of the framed panel on the opening portion fully-open position side and to make heavy the opening portion closing movement, based on the air current, of the framed panel on the opening portion fully-closed position side. Thus, it is possible to suitably provide ventilation by the opening/closing movement, based on the air current, of the framed panel on the opening portion fully-open position side, and it is possible to prevent the rapid opening/closing movement of the framed panel on the opening portion fully-closed position side. In addition, according to the natural ventilation window in accordance with the invention, the first supporting mechanism liftably supports the portion on one side of either the top rail or the bottom rail of the framed panel, while the second supporting mechanism supports the other portion of the framed panel movably in the direction toward the interior or exterior of the building. Hence, it is possible to cause the framed panel to project toward only one side of either the building interior or the building exterior when the opening portion is opened.

In a preferred example of the natural ventilation window in accordance with the invention, the first supporting mechanism is adapted to support the portion on one side of either the top rail or the bottom rail of the framed panel linearly movably in a vertical direction.

In another preferred example of the natural ventilation window in accordance with the invention, the second supporting mechanism is adapted to support the another portion of the framed panel linearly movably in a horizontal direction.

In still another preferred example of the natural ventilation window in accordance with the invention, the another portion of the framed panel in an opening portion fully-open position and the center of gravity of that framed panel are respectively located on an identical line extending in the vertical direction. According to such a preferred example, it is possible to balance the framed panel in the opening portion fully-open position without needing to install a weight or the like on the framed panel, and it is possible to stop the movement of the framed panel directed in the opening portion opening direction without using a stopper or the like. Moreover, it is possible to lighten the opening/closing movement, based on the air current, of the framed panel in the opening portion fully-open position or its vicinity.

In a further preferred example of the natural ventilation window in accordance with the invention, the opening/closing means further includes an engaging member for causing the framed panel to engage a window frame defining the opening portion, so as to maintain a state of the opening portion fully closed by the framed panel.

In a still further preferred example of the natural ventilation window in accordance with the invention, the first supporting mechanism, in particular, is adapted to liftably support a portion on a top rail side of the framed panel, and the another portion of the framed panel is disposed so as to be located below the portion on the top rail side of the framed panel and to be located on the building exterior side relative to the center of gravity of the framed panel in the opening portion fully-closed position. According to such a preferred example, the opening portion can be closed and opened in correspondence with an increase and a decrease of the air current directed particularly from the building exterior toward the building interior.

In a further preferred example of the natural ventilation window in accordance with the invention, the first supporting mechanism, in particular, is adapted to liftably support a portion on a bottom rail side of the framed panel, and the another portion of the framed panel is disposed so as to be located above the portion on the bottom rail side of the framed panel and to be located on the building interior side relative to the center of gravity of the framed panel in the opening portion fully-closed position. According to such a preferred example, the opening portion can be closed and opened in correspondence with an increase and a decrease of the air current directed particularly from the building interior toward the building exterior.

A natural ventilation window according to another aspect of the invention comprises: a window frame which is installed in a building; a framed panel disposed in an opening portion defined by the window frame; and opening/closing means for opening and closing the opening portion on the basis of an air current, the opening/closing means including a first supporting mechanism for supporting a portion on one side of either a top rail or a bottom rail of the framed panel liftably and rotatably about a horizontal axis and a second supporting mechanism for supporting another portion of the framed panel located below or above the portion, movably in a direction toward an interior or exterior of the building and rotatably about the horizontal axis, the another portion of the framed panel being disposed so as to be located above a center of gravity of the framed panel and to be located on one side of either the building interior or the building exterior with respect to that center of gravity when the framed panel is in an opening portion closed position, the second supporting mechanism including a supported member formed in the another portion of the framed panel and a support member which is fitted to the window frame so as to support the supported member, the support member including a linear motion supporting portion for supporting the supported member linearly movably in the direction toward the interior or exterior of the building and rotatably about the horizontal axis and at least one of an end side supporting portion connected to an end portion close to a building interior side of the linear motion supporting portion and adapted to support the supported member movably in a direction intersecting to the direction toward the interior or exterior of the building and rotatably about the horizontal axis, so as to displace the another portion upward at the time of movement of the another portion of the framed panel in a direction toward the interior of the building, and to displace the another portion of the framed panel downward at the time of movement of the another portion in a direction toward the exterior of the building, and an end side supporting portion connected to an end portion close to a building exterior side of the linear motion supporting portion and adapted to support the supported member movably in the direction intersecting to the direction toward the interior or exterior of the building and rotatably about the horizontal axis, so as to displace the another portion of the framed panel downward at the time of movement of the another portion in the direction toward the interior of the building, and to displace the another portion of the framed panel upward at the time of movement of the another portion in the direction toward the exterior of the building.

According to the natural ventilation window in accordance with the another aspect of the invention, the another portion of the framed panel, in particular, is disposed so as to be located above a center of gravity of the framed panel and to be located on one side of either the building interior or the building exterior with respect to that center of gravity when the framed panel is in an opening portion closed position. The second supporting mechanism includes a supported member formed in the another portion of the framed panel and a support member which is fitted to the window frame so as to support the supported member. The support member includes a linear motion supporting portion for supporting the supported member linearly movably in the direction toward the interior or exterior of the building and rotatably about the horizontal axis and at least one of an end side supporting portion connected to an end portion close to a building interior side of the linear motion supporting portion and adapted to support the supported member movably in a direction intersecting to the direction toward the interior or exterior of the building and rotatably about the horizontal axis, so as to displace the another portion upward at the time of movement of the another portion of the framed panel in a direction toward the interior of the building, and to displace the another portion of the framed panel downward at the time of movement of the another portion in a direction toward the exterior of the building, and an end side supporting portion connected to an end portion close to a building exterior side of the linear motion supporting portion and adapted to support the supported member movably in the direction intersecting to the direction toward the interior or exterior of the building and rotatably about the horizontal axis, so as to displace the another portion of the framed panel downward at the time of movement of the another portion in the direction toward the interior of the building, and to displace the another portion of the framed panel upward at the time of movement of the another portion in the direction toward the exterior of the building. Therefore, it is possible to lighten the opening portion closing movement, based on the air current, of the framed panel on the opening portion open position side and to make heavy the opening portion closing movement, based on the air current, of the framed panel on the opening portion closed position side. Thus, it is possible to suitably provide ventilation by the opening/closing movement, based on the air current, of the framed panel on the opening portion open position side. Moreover, in the case where the end side supporting portion close to the building exterior side is provided, it is possible to prevent the rapid opening portion opening movement of the framed panel on the opening portion open position side. In the case where the end side supporting portion close to the building interior side is provided, it is possible to prevent the rapid opening portion closing movement of the framed panel on the opening portion closed position side. In addition, according to the natural ventilation window in accordance with the invention, the first supporting mechanism liftably supports the portion on one side of either the top rail or the bottom rail of the framed panel, while the second supporting mechanism supports the another portion of the framed panel movably in the direction toward the interior or exterior of the building. Hence, it is possible to cause the framed panel to project toward only one side of either the interior or exterior of the building when the opening portion is opened.

In a preferred example of the natural ventilation window according to the another aspect of the invention, the linear motion supporting portion and the end side supporting portion in cooperation with each other form an elongated hole or a slit for guiding the supported member in the direction toward the interior or exterior of the building and in the direction intersecting to the direction toward the interior or exterior of the building.

In another preferred example of the natural ventilation window according to the another aspect of the invention, the first supporting mechanism is adapted to support the portion on one side of either the top rail or the bottom rail of the framed panel linearly movably in the vertical direction.

In still another preferred example of the natural ventilation window according to the another aspect of the invention, the another portion of the framed panel in an opening portion open position and the center of gravity of that framed panel are respectively located on an identical line extending in the vertical direction. According to such a preferred example, it is possible to balance the framed panel in the opening portion open position without needing to install a weight or the like on the framed panel, and it is possible to stop the movement of the framed panel directed in the opening portion opening direction without using a stopper or the like. Moreover, it is possible to lighten the opening/closing movement, based on the air current, of the framed panel in the opening portion open position or its vicinity.

In a further preferred example of the natural ventilation window according to the another aspect of the invention, the opening/closing means has engaging means for causing the framed panel in the opening portion closed position to engage the window frame.

In a still further preferred example of the natural ventilation window according to the another aspect of the invention, the first supporting mechanism may be adapted to support a portion on the top rail side of the framed panel, and the second supporting mechanism may be adapted to support the another portion of the framed panel so as to be located below the portion on the top rail side of the framed panel and to be located on the building exterior side with respect to the center of gravity of the framed panel in a case where the framed panel is in the opening portion closed position. According to such a preferred example, the opening portion can be closed and opened in correspondence with an increase and a decrease of the air current directed particularly from the building exterior toward the building interior. Furthermore, the first supporting mechanism may be adapted to support a portion on the bottom rail side of the framed panel, and the second supporting mechanism may be adapted to support the another portion of the framed panel so as to be located above the portion on the lower rail side of the framed panel and to be located on the building interior side with respect to the center of gravity of the framed panel in a case where the framed panel is in the opening portion closed position. According to such a preferred example, the opening portion can be closed and opened in correspondence with an increase and a decrease of the air current directed particularly from the building interior toward the building exterior.

A natural ventilation window according to still another aspect of the invention comprises: a window frame which is installed in a building; a framed panel disposed in an opening portion defined by the window frame; and opening/closing means for opening and closing the opening portion on the basis of an air current, the opening/closing means including a first supporting mechanism for supporting a portion on a top rail side of the framed panel liftably and rotatably about a horizontal axis and a second supporting mechanism for supporting another portion of the framed panel located below the portion, movably in a direction toward an interior or exterior of the building and rotatably about the horizontal axis, the another portion of the framed panel being disposed so as to be located above a center of gravity of the framed panel and to be located on a building exterior side with respect to that center of gravity when the framed panel is in an opening portion closed position, the second supporting mechanism including: a supported member formed in the another portion of the framed panel; a support member for supporting the supported member linearly movably in the direction toward the interior or exterior of the building and rotatably about the horizontal axis; a rotating shaft for connecting the support member to the window frame rotatably about the horizontal axis so as to be located below the supported member in a state of being supported by the support member linearly movably in the direction toward the interior or exterior of the building and on a building interior side; a guide member which is fitted to the window frame and abuts against the supported member located close to the building interior side, so as to upwardly guide the supported member on the basis of the linear motion of the supported member in the direction toward the interior of the building and to downwardly guide the supported member on the basis of the linear motion of the supported member in the direction toward the exterior of the building; and a holding mechanism for holding an angle of rotation of the support member in a state of supporting the supported member linearly movably in the direction toward the interior or exterior of the building.

According to the natural ventilation window in accordance with the still another aspect of the invention, the other portion of the framed panel, in particular, is disposed so as to be located above the center of gravity of the framed panel and to be located on the building exterior side with respect to that center of gravity when the framed panel is in the opening portion closed position. The second supporting mechanism includes the following: the supported member formed in the another portion of the framed panel; the support member for supporting the supported member linearly movably in the direction toward the interior or exterior of the building and rotatably about the horizontal axis; the rotating shaft which connects the support member to the window frame rotatably about the horizontal axis so as to be located below the supported member in the state of being supported by the support member linearly movably in the direction toward the interior or exterior of the building and on the building interior side; the guide member which is fitted to the window frame and abuts against the supported member located close to the building interior side, so as to upwardly guide the supported member on the basis of the linear motion of that supported member in the direction toward the interior of the building and to downwardly guide the supported member on the basis of the linear motion of the supported member in the direction toward the exterior of the building; and the holding mechanism for holding the angle of rotation of the support member in the state of supporting the supported member linearly movably in the direction toward the interior or exterior of the building. Therefore, it is possible to lighten the opening portion closing movement, based on the air current, of the framed panel on the opening portion open position side and to make heavy the opening portion closing movement, based on the air current, of the framed panel on the opening portion closed position side. Thus, it is possible to suitably provide ventilation by the opening/closing movement, based on the air current, of the framed panel on the opening portion open position side. As the closing movement resisting force of the opening portion, which resists the opening portion closing movement of the framed panel, is generated by the guiding of the supported member by the guide member, it is possible to prevent the rapid opening portion closing movement of the framed panel on the opening portion closed position side. Moreover, as the support member undergoes rotation toward the building interior side on the basis of the linear motion of the supported member in the direction toward the interior of the building, the support member projects to neither the building interior side nor the building exterior side in the case where the framed panel is in the opening portion closed position.

In a preferred example of the natural ventilation window in accordance with the still another aspect of the invention, the support member includes: a linear motion supporting portion for supporting the supported member linearly movably in the direction toward the interior or exterior of the building and rotatably about the horizontal axis; and an end side supporting portion which is close to the building exterior side and is connected to an end portion close to the building exterior side of the linear motion supporting portion, the end side supporting portion being adapted to support the supported member movably in a direction intersecting to the direction toward the interior or exterior of the building and rotatably about the horizontal axis, so as to displace the another portion of the framed panel downward at the time of movement of the another portion in the direction toward the interior of the building, and to displace the another portion of the framed panel upward at the time of movement of the another portion in the direction toward the exterior of the building. According to such a preferred example, it is possible to prevent the rapid opening portion opening movement of the Framed panel on the opening portion open position side in the end side supporting portion close to the building exterior side.

In another preferred example of the natural ventilation window in accordance with the still another aspect of the invention, the linear motion supporting portion and the end side supporting portion in cooperation with each other form an elongated hole or a slit for guiding the supported member in the direction toward the interior or exterior of the building and in the direction intersecting to the direction toward the interior or exterior of the building.

In still another preferred example of the natural ventilation window in accordance with the still another aspect of the invention, the support member further includes an end side supporting portion which is close to the building interior side and is connected to an end portion close to the building interior side of the linear motion supporting portion, the end side supporting portion having a more enlarged portion of the elongated hole or the slit than a portion of the elongated hole or the slit formed in the linear motion supporting portion and being adapted to support the supported member in the enlarged portion.

In a further preferred example of the natural ventilation window in accordance with the still another aspect of the invention, the guide member is fitted to the window frame so as to abut against the supported member before or simultaneously as the rotation based on the linear motion of the supported member in the direction toward the interior of the building is generated in the support member. According to such a preferred example, it is possible to prevent the closing movement resisting force of the opening portion, which resists the opening portion closing movement force of the framed panel, from becoming momentarily excessively large at the portion close to the building interior side of the support member.

In a still further preferred example of the natural ventilation window in accordance with the still another aspect of the invention, the first supporting mechanism is adapted to support the portion on the top rail side of the framed panel linearly movably in a vertical direction.

In a further preferred example of the natural ventilation window in accordance with the still another aspect of the invention, the first supporting mechanism has an urging member for resiliently urging the portion on the top rail side of the framed panel downward with respect to the window frame, so as to impart a moving force in an opening portion opening direction to the framed panel.

In a further preferred example of the natural ventilation window in accordance with the still another aspect of the invention, the another portion of the framed panel in an opening portion open position and the center of gravity of that framed panel are respectively located on an identical line extending in the vertical direction. According to such a preferred example, it is possible to balance the framed panel in the opening portion open position without needing to install a weight or the like on the framed panel, and it is possible to stop the movement of the framed panel toward the opening portion opening direction without using a stopper or the like. Moreover, it is possible to lighten the opening/closing movement, based on the air current, of the framed panel in the opening portion open position or its vicinity.

In a further preferred example of the natural ventilation window in accordance with the still another aspect of the invention, the opening/closing means has engaging means for causing the framed panel in the opening portion closed position to engage the window frame.

### ADVANTAGES OF THE INVENTION

According to the invention, it is possible to provide a natural ventilation window which makes it possible to lighten the opening portion closing movement, based on the air current of the framed panel on the opening portion fully-open position side and to make heavy the opening portion closing movement, based on the air current, of the framed panel on the opening portion fully-closed position side, thereby making it possible to suitably provide ventilation by the opening/closing movement, based on the air current, of the framed panel on the opening portion fully-open position side and to prevent the rapid opening/closing movement of the framed panel on the opening portion fully-closed position side.

According to the invention, it is possible to provide a natural ventilation window which makes it possible to lighten the opening portion closing movement, based on the air current, of the framed panel on the opening portion open position side and to make heavy the opening portion closing movement, based on the air current, of the framed panel on the opening portion closed position side, thereby making it possible to suitably provide ventilation by the opening/closing movement, based on the air current, of the framed panel on the opening portion open position side and to prevent the rapid opening portion opening movement of the framed panel on the opening portion open position side and the rapid opening portion closing movement of the framed panel on the opening portion closed position side.

According to the invention, it is possible to provide a natural ventilation window which makes it possible to lighten the opening portion closing movement, based on the air current, of the framed panel on the opening portion open position side and to make heavy the opening portion closing movement, based on the air current, of the framed panel on the opening portion closed position side, thereby making it possible to suitably provide ventilation by the opening/closing movement, based on the air current, of the framed panel on the opening portion open position side, and in which nothing is made to project on both the building interior side and the building exterior side when the framed panel is in the opening portion closed position.

Next, a more detailed description will be given of a mode for carrying out the invention with reference to the preferred embodiments illustrated in the drawings. It should be noted that the invention is not limited to these embodiments.

### BRIEF DESCRIPTION OF THE DRAWINGS

FIG. 1 is an explanatory side elevational view in accordance with an embodiment of the invention;

FIG. 2 is an explanatory plan view of the embodiment shown in FIG. 1;

FIG. 3 is a diagram explaining the operation of the embodiment shown in FIG. 1;

FIG. 4 is an explanatory side elevational view in an opening portion open state in accordance with another embodiment of the invention;

FIG. 5 is an explanatory side elevational view in the opening portion closed state of the embodiment shown in FIG. 4;

FIG. 6 is an explanatory plan view of the embodiment shown in FIG. 5;

FIG. 7 is an explanatory diagram of mainly a second supporting mechanism of the embodiment shown in FIG. 4;

FIG. 8 is a diagram explaining the operation of the embodiment shown in FIG. 4;

FIG. 9 is a diagram explaining the operation of the embodiment shown in FIG. 4;

FIG. 10 is an explanatory side elevational view in an opening portion open state in accordance with still another embodiment of the invention;

FIG. 11 is an explanatory side elevational view in the opening portion fully-open state in accordance with the embodiment shown in FIG. 10;

FIG. 12 a diagram explaining the operation of the embodiment shown in FIG. 10;

FIG. 13 is an explanatory side elevational view in the opening portion closed state of the embodiment shown in FIG. 10;

FIG. 14 is an explanatory plan view of the embodiment shown in FIG. 13;

FIG. 15 is an explanatory side elevational view with a framed panel omitted in the opening portion closed state of the embodiment shown in FIG. 10;

FIG. 16 is an enlarged explanatory view of mainly a second supporting mechanism in the opening portion open state of the embodiment shown in FIG. 10;

FIG. 17 is an enlarged explanatory view of mainly the second supporting mechanism in the opening portion closed state of the embodiment shown in FIG. 10;

FIG. 18 is an enlarged explanatory diagram of mainly a guide member of the second supporting mechanism of the embodiment shown in FIG. 10 and

FIG. 19 is an explanatory diagram of another second supporting mechanism of the embodiment shown in FIG. 10.

### BEST MODE FOR CARRYING OUT THE INVENTION

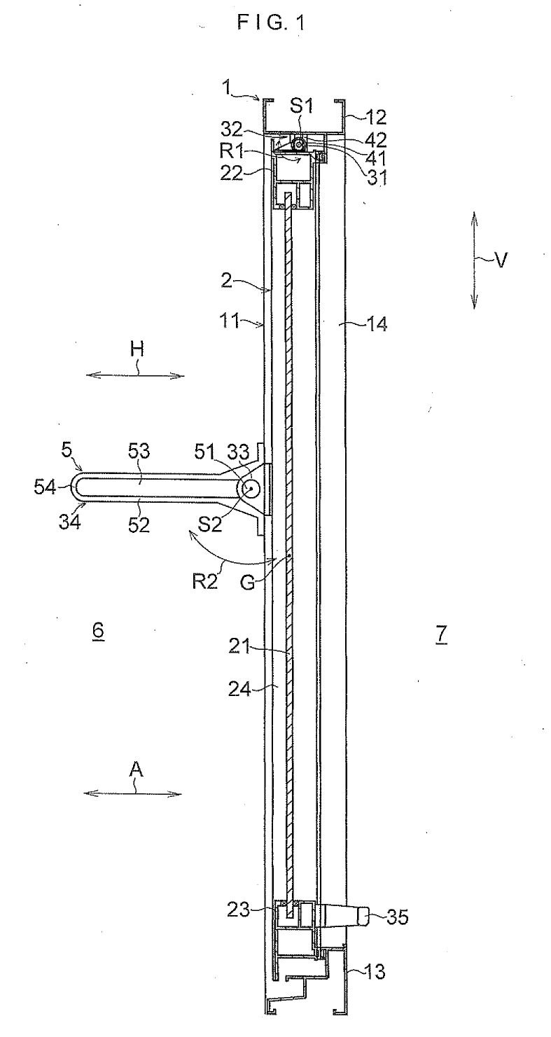

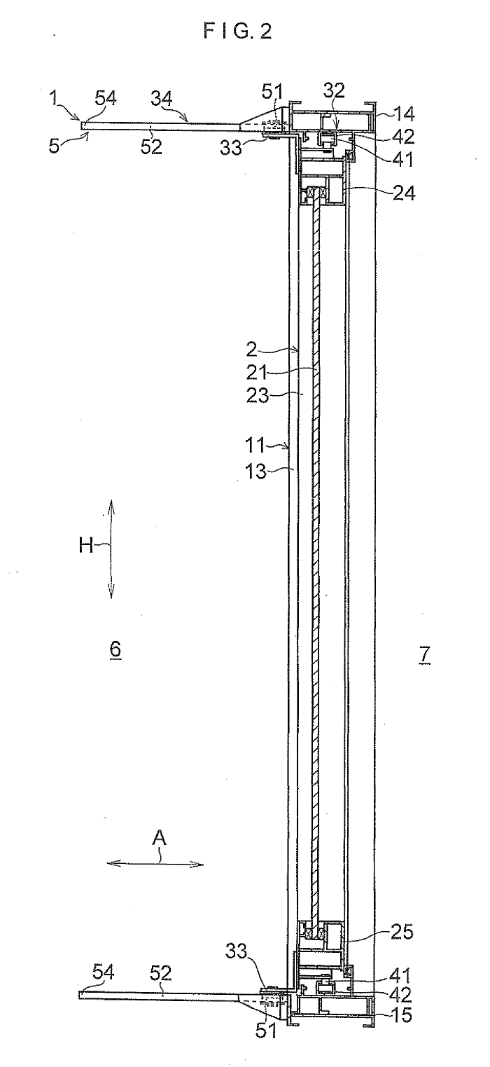

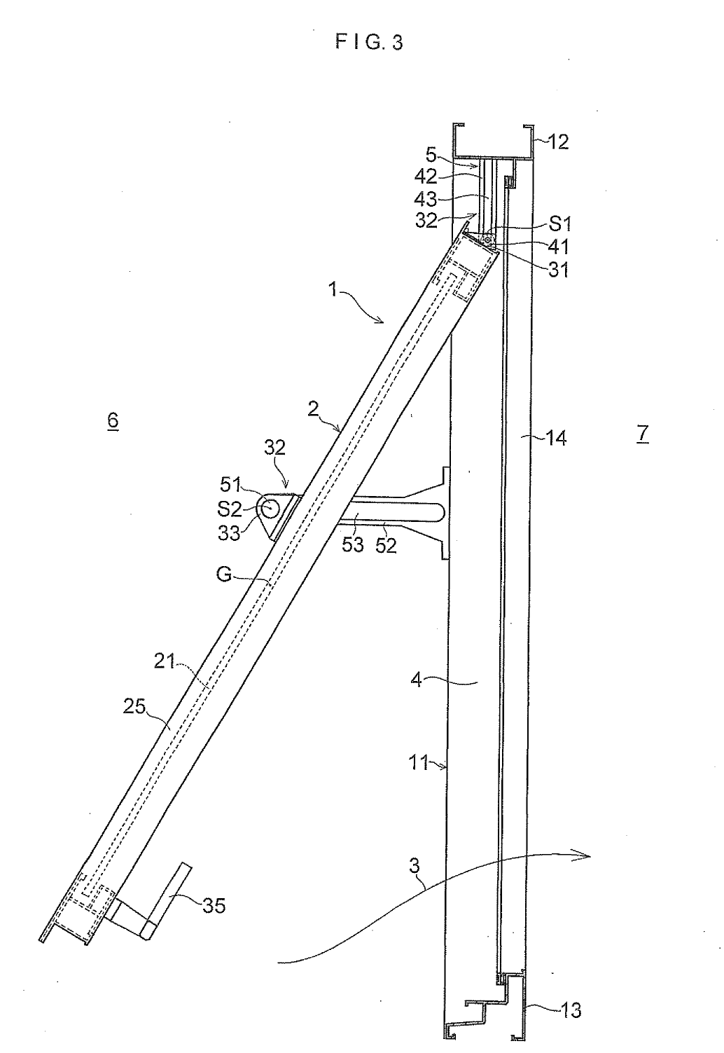

In FIGS. 1 to 3, a natural ventilation window 1 in accordance with this embodiment is comprised of a framed panel 2 and an opening/closing means 5 for causing the framed panel 2 to open and close an opening portion 4 of a building on the basis of an air current 3. The natural ventilation window 1 is adapted to open the opening portion 4, as shown in FIG. 3, by the opening portion opening movement of the framed panel 2 moving toward a building exterior 6 side, and is adapted to close the opening portion 4, as shown in FIG. 1, by the opening portion closing movement of the framed panel 2 moving toward a building interior 7 side.

The opening portion 4 is defined by a window frame 11 installed in the building. The window frame 11 has an upper frame 12, a lower frame 13, and a pair of vertical frames 14 and 15. A seal member for abutting against the framed panel 2 in an opening portion fully-closed position, as shown in FIG. 1, is fitted to the upper frame 12, the lower frame 13, and the vertical frames 14 and 15.

The framed panel 2 is fitted to the window frame 11 by means of the opening/closing means 5. The framed panel 2 has a rectangular framed panel body 21 constituted by a glass plate or the like, a top rail 22, a bottom rail 23, and a pair of stiles 24 and 25. Portions 33 of the stiles 24 and 25, into which support shafts 51 are respectively fitted, project to the building exterior 6 side in this embodiment.

The opening/closing means 5 includes a supporting mechanism 32 for supporting a portion 31 on the top rail 22 side of the framed panel 2 liftably and rotatably about a horizontal axis S1 in an R1 direction; a supporting mechanism 34 for supporting a portion 33 of the framed panel 2, which is located below the portion 31, movably in a direction A toward the interior or exterior of the building and rotatably about a horizontal axis S2 in an R2 direction; and an engaging member 35 for causing the framed panel 2 to engage the window frame 11 defining the opening portion 4, so as to maintain the state of the opening portion fully closed by the framed panel 2. The portions 31 and 33 are respectively provided in the stiles 24 and 25. The horizontal axes S1 and S2 extend in a direction perpendicular to a vertical direction V and the direction A toward the interior or exterior of the building. The direction A toward the interior or exterior of the building in this embodiment is also a horizontal direction (a direction within a horizontal plane) H, but may also be, for example, a direction which is inclined upward or downward with respect to the horizontal direction H from the building interior 7 toward the building exterior 6.

The supporting mechanism 32 includes a support shaft 41 fitted in the respective one of the portion 31 of the stile 24 and the portion 31 of the stile 25 and extending in the horizontal direction H, as well as a guide member 42 which is fitted to the respective one of the vertical frames 14 and 15 so as to linearly guide the support shaft 41 in the vertical direction V and which extends in the vertical direction V.

The guide member 42 has a U-shaped cross section so as to form a groove 43 extending in the vertical direction V. The support shaft 41 is disposed in the groove 43 linearly movably in the vertical direction V and rotatably about the horizontal axis S1. The guide member 42 is formed so as to be of a length identical to or longer than the distance whereby the support shaft 41 moves linearly in the vertical direction V in conjunction with the opening or closing movement of the framed panel 2. A rolling roller may be fitted at the portion of the support shaft 41 which is disposed in the groove 43. It should be noted that, in order to prevent the support shaft 41 from being lowered more than the position of the support shaft 41 in an opening portion fully-open state with respect to the guide member 42, the supporting mechanism 32 may further include a stopper for abutting against the support shaft 41 at that position.

The portion 31 having the horizontal axis S1 as its center is located above a center of gravity C of the framed panel 2 in the opening portion closed position. The portion 31 in this embodiment is located slightly on the building interior 7 side with respect to the aforementioned center of gravity G in the direction A toward the interior or exterior of the building. Such a supporting mechanism 32 is adapted to support the portion 31 linearly movably in the vertical direction V.

The supporting mechanism 34 includes the support shaft 51 fitted in the respective one of the portion 33 of the stile 24 and the portion 33 of the stile 25 and extending in the horizontal direction H, as well as a guide member 52 which is fitted to the respective one of the vertical frames 14 and 15 so as to linearly guide the support shaft 51 in the direction A toward the interior or exterior of the building and which extends in the direction A toward the interior or exterior of the building.

The support shaft 51 and the portion 33 having the horizontal axis S2 as their center are located above the center of gravity G of the framed panel 2 in the opening portion fully-closed position, and are located on the building exterior 6 side with respect to that center of gravity G. The portion 33 and the support shaft 51 as well as the center of gravity C of the framed panel 2 in the opening portion fully-open position are respectively located on an identical line extending in the vertical direction V.

The guide member 52 has an elongated hole 53 extending in the direction A toward the interior or exterior of the building. The support shaft 51 is disposed in the elongated hole 53 linearly movably in the direction A toward the interior or exterior of the building and rotatably about the horizontal axis S2. The guide member 52 is formed so as to be of a length identical to or longer than the distance whereby the support shaft 51 moves linearly in the direction A toward the interior or exterior of the building in conjunction with the opening or closing movement of the framed panel 2. One end 54 on the building exterior 6 side of the guide member 52 in which the elongated hole 53 is defined has the function as a stopper for abutting against the support shaft 51 in order to prevent the support shaft 51 from moving to the building exterior 6 side beyond the position of the support shaft 51 in the opening portion fully-open state. A rolling roller may be fitted at the portion of the support shaft 51 which is disposed in the elongated groove 53.

A line connecting the portion 33 and the center of gravity G of the framed panel 2 in the opening portion fully-closed position is inclined with respect to a line extending in the vertical direction V. Such an angle of inclination becomes smaller as the framed panel 2 approaches the opening portion fully-open position, and becomes 0 degree when the framed panel 2 is disposed in the opening portion fully-open position. Such a supporting mechanism 34 is adapted to support the portion 33 linearly movably in the direction A toward the interior or exterior of the building among the horizontal directions H.

The engaging member 35 is constituted by an L-shaped lever fitted rotatably to the bottom rail 23. As such a lever is rotatively operated in the opening portion fully-closed state, the lever abuts against the lower frame 13 on the building interior 7 side and is thereby adapted to allow the framed panel 2 to engage the window frame 11. The movement toward the opening portion fully-open position of the framed panel 2 engaged with the window frame 11 installed in the building by means of the engaging member 35 is prevented cancellably by that engaging member 35.

A description will be given of the window opening and closing operation by the above-described natural ventilation window 1. First, the opening portion opening movement of the framed panel 2 which is in the opening portion fully-closed position, as shown in FIG. 1, is allowed by canceling the engagement between the framed panel 2 and the window frame 11 by lie engaging member 35. When the engagement is canceled, a rotational moment in the R2 direction toward the opening portion fully-open position is imparted to the framed panel 2 in the opening portion fully-closed position since the portion 33 is located on the building exterior 6 side relative to the center of gravity G in the direction A toward the interior or exterior of the building. The framed panel 2, to which such a rotational moment has been imparted and for which the movement toward the opening portion fully-open position has been allowed, rotates in the R2 direction toward the opening portion fully-open position. In conjunction with that rotation in the R2 direction, the support shaft 41 is lowered along the groove 43. When the framed panel 2 reaches the opening portion fully-open position, as shown in FIG. 3, the portion 33 and the center of gravity G are located on the identical line extending in the vertical direction V, so that the rotational moment in the R2 direction ceases to be imparted to the framed panel 2. The rotational moment in the R2 direction toward the opening portion fully-open position, which is imparted to the framed panel 2, decreases gradually as the framed panel 2 is gradually moved from the opening portion fully-closed position toward the opening portion fully-open position. Since the aforementioned rotational moment thus decreases gradually, it is possible to prevent rapid opening portion opening by the framed panel 2. Meanwhile, in a case where the framed panel 2 is conversely moved gradually from the opening portion fully-open position toward the opening portion fully-closed position, the rotational moment in the R2 direction toward the opening portion fully-open position, which is imparted to the framed panel 2, increases gradually.

In the case where the framed panel 2 is disposed in the opening portion fully-open position, as described above, when the building exterior 6 side assumes a positive pressure and the building interior 7 side assumes a negative pressure with respect to the framed panel 2 owing to the air current 3, a rotational moment in the R2 direction toward the opening portion fully-closed position on the basis of the air current 3 is imparted to the framed panel 2, so that that framed panel 2 is moved toward the opening portion closed position. When the framed panel 2 is further moved toward the opening portion fully-closed position on the basis of the air current 3, since the portion 33 is located on the building exterior 6 side with respect to the center of gravity G, a counter moving force toward the opening portion fully-open position, which resists the movement toward the opening portion fully-closed position on the basis of the air current 3, is imparted to the framed panel 2. Such a counter moving force increases gradually as the framed panel 2 approaches the opening portion fully-closed position. Thus, even with a small air current 3, the opening and closing movement of the framed panel 2 can be generated on the basis of that air current 3, and it is also possible to prevent the rapid closing of the opening portion by the framed panel 2.

The natural ventilation window 1 in accordance with this embodiment includes the supporting mechanism 32 for supporting the portion 31 on the top rail 22 side of the framed panel 2, as well as the supporting mechanism 34 for supporting the other portion 33 of the framed panel 2 which is located below the portion 31 and above the center of gravity of the framed panel 2 and on the building exterior 6 side relative to the center of gravity G of the framed panel 2 in the opening portion fully-closed position. In substitution of these, the natural ventilation window 1 may include, for example, a first supporting mechanism for supporting a portion on the bottom rail 23 side of the framed panel 2 liftably and rotatably about a horizontal axis, as well as a second supporting mechanism for supporting another portion of the framed panel 2 located above that portion on the bottom rail 23 side of the framed panel 2, movably in the direction A toward the interior or exterior of the building and rotatably about a horizontal axis. Furthermore, the other portion of the framed panel 2 may be disposed so as to be located above the center of gravity G of the framed panel 2 in the opening portion fully-closed position and to be located on the building interior 7 side relative to that center of gravity G. The above- and below-described operational effects can also be demonstrated by the natural ventilation window 1 having such first and second supporting mechanisms.

According to the above-described natural ventilation window 1, the natural ventilation window 1 is comprised of the framed panel 2 and the opening/closing means 5 for causing the framed panel 2 to open and close the opening portion 4 of the building on the basis of the air current 3. The opening/closing means 5 includes the supporting mechanism 32 for supporting the portion 31 on one side of either the top rail 22 or the bottom rail 23 of the framed panel 2 liftably and rotatably about the horizontal axis S1 in the R1 direction, as well as the supporting mechanism 34 for supporting the portion 33 of the framed panel 2, which is located below or above the portion 31, movably in the direction A toward the interior or exterior of the building and rotatably about the horizontal axis S2 in the R2 direction. The portion 33 is disposed so as to be located above the center of gravity G of the framed panel 2 in the opening portion fully-closed position and to be located on one side of either the building exterior 6 or the building interior 7 with respect to that center of gravity G. Therefore, it is possible to lighten the opening portion closing movement, based on the air current 3, of the framed panel 2 on the opening portion fully-open position side and to make heavy the opening portion closing movement, based on the air current 3, of the framed panel 2 on the opening portion fully-closed position side. Thus, it is possible to suitably provide ventilation by the opening/closing movement, based on the air current 3, of the framed panel 2 on the opening portion fully-open position side, and it is possible to prevent the rapid opening/closing movement of the framed panel 2 on the opening portion fully-closed position side. In addition, the supporting mechanism 32 liftably supports the portion 31 on one side of either the top rail 22 or the bottom rail 23 of the framed panel 2, while the supporting mechanism 34 supports the portion 33 of the framed panel 2 movably in the direction A toward the interior or exterior of the building. Hence, it is possible to cause the framed panel 2 to project toward only one side of either the building exterior 6 or the building interior 7 when the opening portion 4 is opened.

According to the natural ventilation window 1, the portion 33 of the framed panel 2 in the opening portion fully-open position and the center of gravity G of that framed panel 2 are respectively located on an identical line extending in the vertical direction V. Therefore, it is possible to balance the framed panel 2 in the opening portion fully-open position without needing to install a weight or the like on the framed panel 2, and it is possible to stop the movement of the framed panel 2 directed in the opening portion opening direction without using a stopper or the like. Moreover, it is possible to lighten the opening/closing movement based on the air current 3, of the framed panel 2 in the opening portion fully-open position or its vicinity.

In the natural ventilation window 1, the supporting mechanism 32 may be adapted to liftably support the portion 31 on the top rail 22 side of the framed panel 2, and the portion 33 of the framed panel 2 may be disposed so as to be located below the portion 31 on the top rail 22 side of the framed panel 2 and to be located on the building exterior 6 side relative to the center of gravity G of the framed panel 2 in the opening portion fully-closed position. In such a case, the opening portion 4 can be closed and opened particularly in correspondence with an increase and decrease of the air current 3 directed from the building exterior 6 toward the building interior 7. On the other hand, in the natural ventilation window 1, the supporting mechanism 32 may be adapted to liftably support a portion on the bottom rail 23 side of the framed panel 2, and another portion of the framed panel 2 may be disposed so as to be located above that portion on the bottom rail 23 side of the framed panel 2 and to be located on the building interior 7 side relative to the center of gravity G of the framed panel 2 in the opening portion fully-closed position. In such a case, the opening portion 4 can be closed and opened particularly in correspondence with an increase and decrease of the air current 3 directed from the building interior 7 toward the building exterior 6.

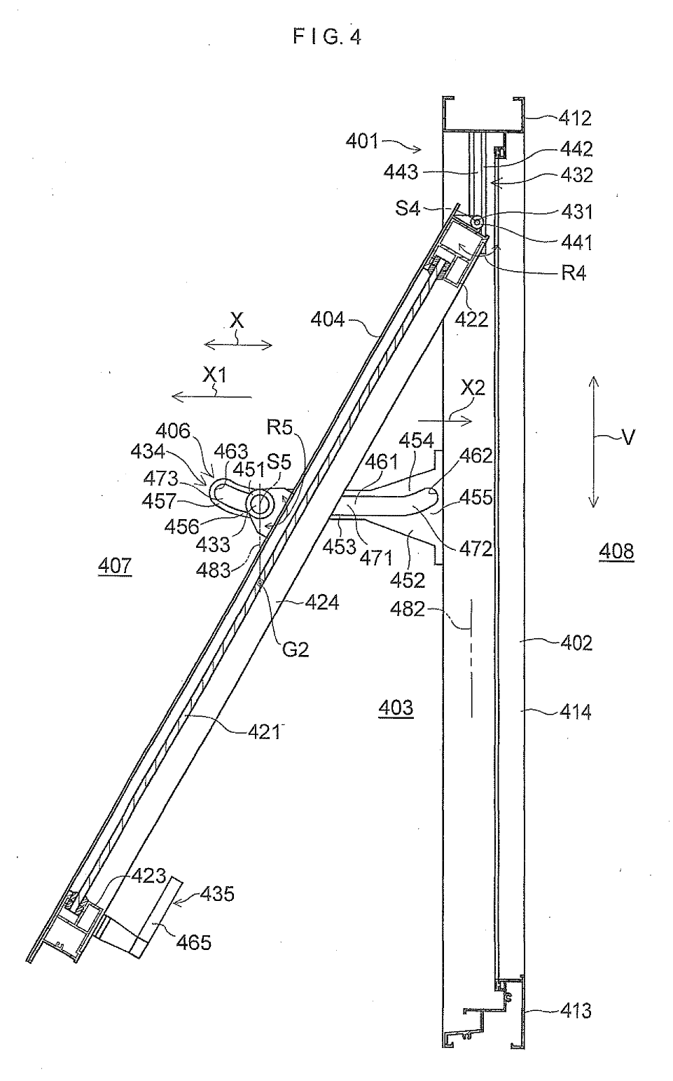

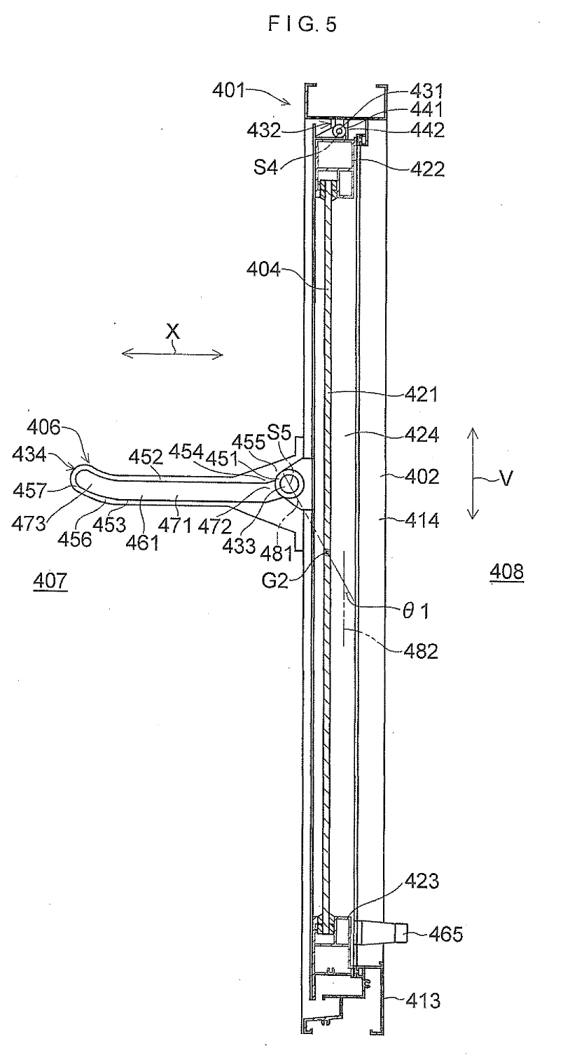

In FIGS. 4 to 9, a natural ventilation window 401 in accordance with another embodiment is comprised of a window frame 402 which is installed in a building (not shown); a framed panel 404 disposed in an opening portion 403 defined by the window frame 402; and an opening/closing means 406 for opening and closing the opening portion 403 on the basis of an air current. The natural ventilation window 401 is adapted to open the opening portion 403, as shown in FIG. 4, by the opening portion opening movement of the framed panel 404 moving toward a building exterior 407 side, and is adapted to close the opening portion 403, as shown in FIG. 5, by the opening portion closing movement of the framed panel 404 moving toward a building interior 408 side.

The window frame 402 has an upper frame 412, a lower frame 413, and a pair of vertical frames 414 and 415. A seal member for abutting against the framed panel 404 in the opening portion open position, as shown in FIG. 4, is fitted to the upper frame 412, the lower frame 413, and the vertical frames 414 and 415.

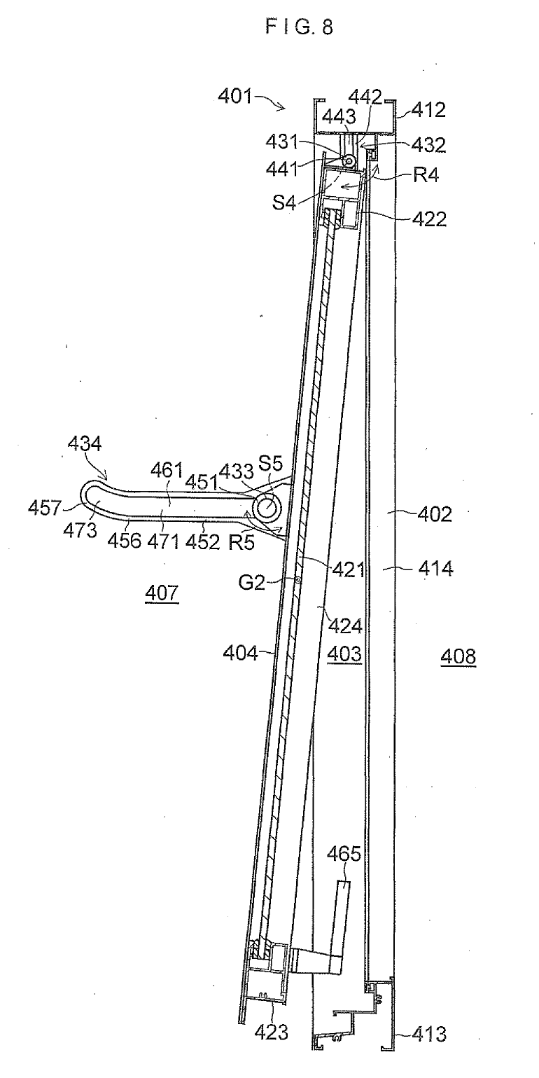

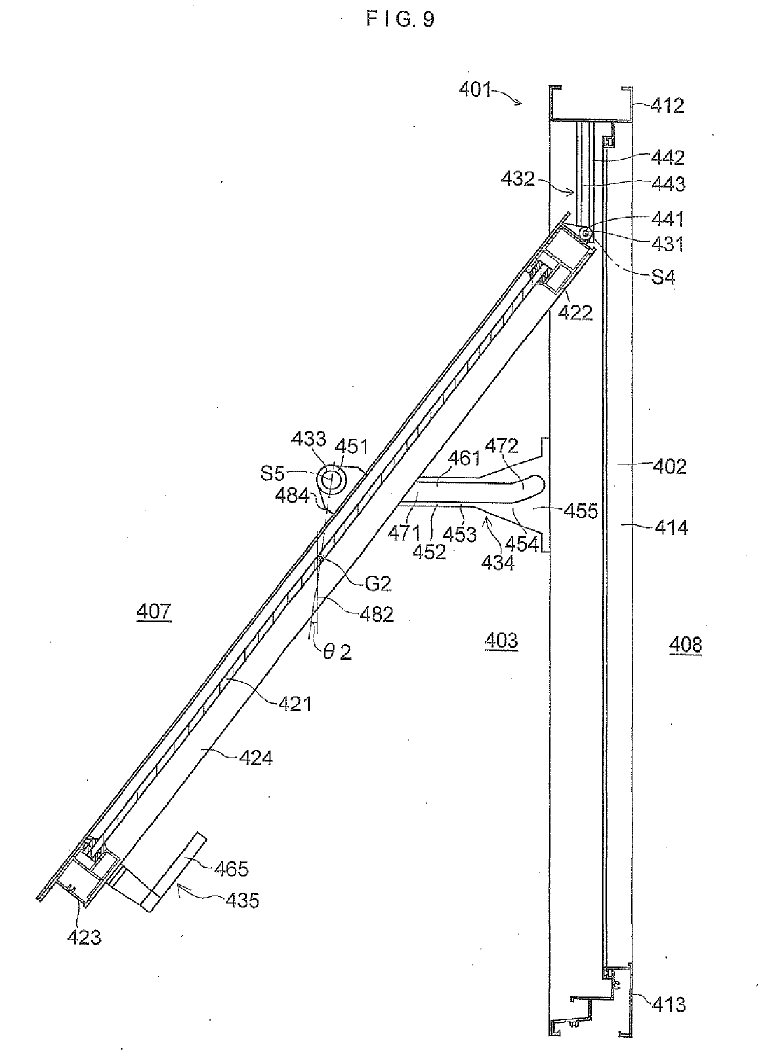

The framed panel 404 is fitted to the window frame 402 by means of the opening/closing means 406. The framed panel 404 has a rectangular framed panel body 421 constituted by a glass plate or the like, a top rail 422, a bottom rail 423, and a pair of stiles 424 and 425. Portions of the stiles 424 and 425, into which shaft bodies 451 serving as members to be supported are respectively fitted, project to the building exterior 407 side with respect to the framed panel body 421 in this embodiment. The framed panel 404 fitted to the window frame 402 in such a manner as to be capable of freely opening and closing the opening portion 403 by means of the opening/closing means 406 assumes a stationary state in the opening portion open position shown in FIG. 4, and is adapted to narrow the opening portion 403, as shown in FIG. 8, by the opening portion closing movement based on the air current and to expand the opening portion 403, as shown in FIG. 9, by the opening portion opening movement based on the air current.

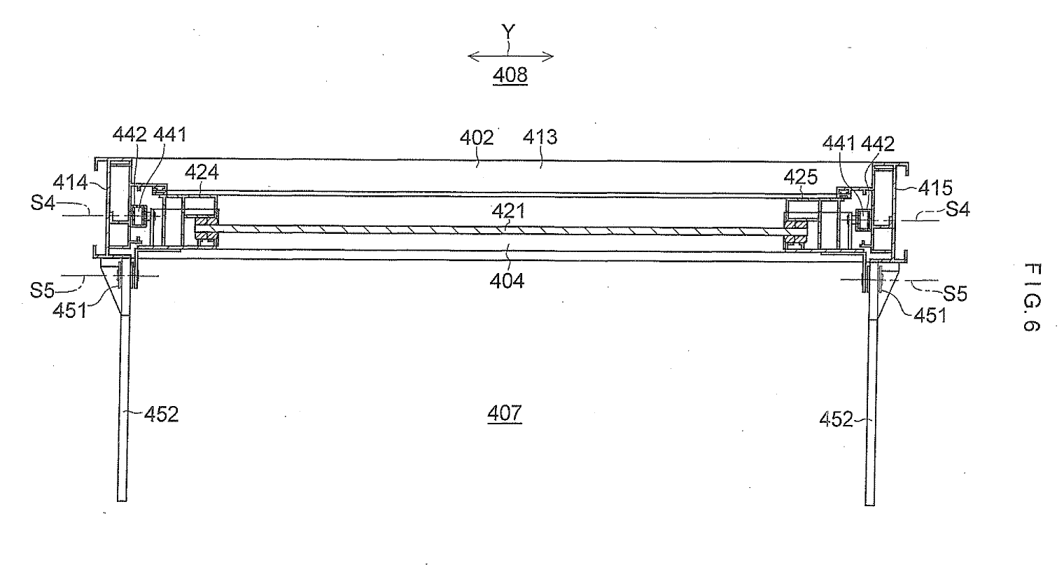

The opening/closing means 406 includes a supporting mechanism 432 for supporting a portion 431 on the top rail 422 side of the framed panel 404 liftably in the vertical direction V and rotatably about a horizontal axis S4 in an R4 direction; a supporting mechanism 434 for supporting another portion 433 of the framed panel 404, which is located below the portion 431, movably in a direction X toward the interior or exterior of the building and rotatably about a horizontal axis S4 in an R5 direction; and an engaging means 435 for causing the framed panel 404 in the opening portion closed position to engage the window frame 402. The portions 431 and 433 are respectively provided in the stiles 424 and 425. The horizontal axes S4 and S5 extend in a lateral direction Y which is shown in FIG. 6 and is perpendicular to the vertical direction V and the direction X toward the interior or exterior of the building. The direction X toward the interior or exterior of the building in this embodiment is a direction which is parallel to the horizontal direction and is perpendicular to the lateral direction Y, but may also be, for example, a direction which is inclined upward or downward with respect to the horizontal direction (direction within a horizontal plane) from the building interior 408 side toward the building exterior 407 side. The portion 433 is disposed so as to be located above a center of gravity G2 of the framed panel 404 and to be located on the building exterior 407 side with respect to that center of gravity G2 when the framed panel 404 is in the opening portion closed position.

The supporting mechanism 432 includes a shaft body 441 which is fitted in the respective one of the portion 431 of the stile 424 and the portion 431 of the stile 425, as well as a guide member 442 which is fitted to the respective one of the vertical frames 414 and 415 so as to linearly guide the shaft body 441 in the vertical direction V and which extends in the vertical direction V.

The guide member 442 has a U-shaped cross section so as to form a groove 443 extending in the vertical direction V. The shaft body 441 is disposed in the groove 443 linearly movably in the vertical direction V and rotatably about the horizontal axis S4. The guide member 442 is formed so as to be of a length identical to or longer than the distance whereby the shaft body 441 moves linearly in the vertical direction V in conjunction with the opening or closing movement of the framed panel 404. A rolling roller may be fitted at the portion of the shaft body 441 which is disposed in the groove 443. It should be noted that, in order to prevent the shaft body 441 from being lowered more than the position of the shaft body 441 in the opening portion open state, shown in FIG. 4, with respect to the guide member 442, the supporting mechanism 432 may further include a stopper for abutting against the shaft body 441 at that position. In conjunction with the opening portion opening movement and the opening portion closing movement of the framed panel 404, the shaft body 441 is raised and lowered in the vertical direction V with respect to the guide member 442 and is rotated about the horizontal axis S4 as an axis with respect to that guide member 442.

As shown in FIG. 5, the portion 431 having the horizontal axis S4 as its center is located above the center of gravity G2 of the framed panel 404 in the opening portion closed position. The portion 431 in this embodiment is located slightly on the building interior 408 side with respect to the aforementioned center of gravity G2 in the direction X toward the interior or exterior of the building. Such a supporting mechanism 432 is adapted to support the portion 431 linearly movably in the vertical direction V and rotatably about the horizontal axis S4.

It should be noted that the supporting mechanism 432 may further include a spring serving as an urging member for resiliently urging the portion 431 downward, so as to impart a moving force in the opening portion opening direction to the framed panel 4.

The supporting mechanism 434 includes the shaft body 451 serving as a supported member formed in the respective one of the portion 433 of the stile 424 and the portion 433 of the stile 425 and extending in the lateral direction Y, as well as a support member 452 which is fitted to the respective one of the vertical frames 414 and 415 so as to support the shaft body 451.

In the case where the framed panel 404 is in the opening portion closed position, as shown in FIG. 5, the shaft body 451 and the portion 433 having the horizontal axis S5 as their center are located above the center of gravity G2 of the framed panel 404 and are located on the building exterior 407 side with respect to that center of gravity G2. On the other hand, in the case where the framed panel 404 is in the opening portion open position, as shown in FIG. 4, the portion 433 and the shaft body 451 as well as the center of gravity 62 of the framed panel 404 are respectively located on an identical line extending in the vertical direction V.

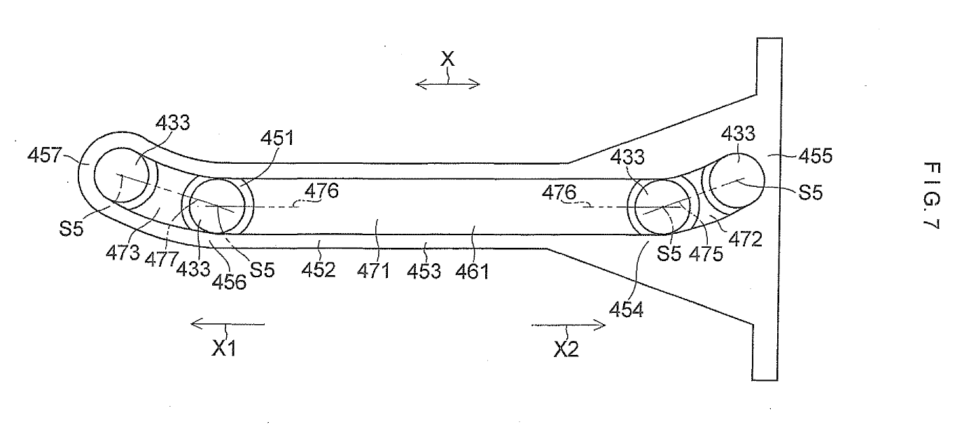

As shown in FIG. 7, for instance, the support member 452 includes the following: a linear motion supporting portion 453 for supporting the shaft body 451 linearly movably in the direction X toward the interior or exterior of the building and rotatably about the horizontal axis S5 in the R5 direction; an end side supporting portion 455 connected to an end portion 454 close to the building interior 408 side of the linear motion supporting portion 453 and adapted to support the shaft body 451 movably in a direction intersecting to the direction X toward the interior or exterior of the building and rotatably about the horizontal axis S5 in the R5 direction, so as to displace the portion 433 of the framed panel 404 upward with respect to the vertical direction V at the time of movement of that portion 433 in a direction X2 toward the interior of the building, and to displace the portion 433 of the framed panel 404 downward with respect to the vertical direction V at the time of movement of that portion 433 in a direction X1 toward the exterior of the building; and an end side supporting portion 457 connected to an end portion 456 close to the building exterior 407 side of the linear motion supporting portion 453 and adapted to support the shaft body 451 movably in a direction intersecting to the direction X toward the interior or exterior of the building and rotatably about the horizontal axis S5 in the R5 direction, so as to displace the portion 433 of the framed panel 404 downward with respect to the vertical direction V at the time of movement of that portion 433 toward the direction X2 toward the interior of the building, and to displace the portion 433 of the framed panel 404 upward with respect to the vertical direction V at the time of movement of that portion 433 toward the direction X1 toward the exterior of the building. The end side supporting portions 455 are respectively secured to the vertical frames 414 and 415.

The linear motion supporting portion 453 and the end side supporting portions 455 and 457 in cooperation with each other form an elongated hole or a slit, i.e., an elongated hole 461 in this embodiment, for guiding the shaft body 451 in the direction X toward the interior or exterior of the building and in a direction intersecting to the direction X toward the interior or exterior of the building. The shaft body 451 is disposed in the elongated hole 461 linearly movably in the direction X toward the interior or exterior of the building and rotatably about the horizontal axis S5 in the R5 direction. An end face 462 on the building interior 408 side of the elongated hole 461, which is formed by the end side supporting portion 455, is adapted to abut against the shaft body 451 so as to suppress the opening portion closing movement by more than a predetermined amount of the portion 433 of the framed panel 404. An end face 463 on the building exterior 407 side of the elongated hole 461, which is formed by the end side supporting portion 457, is adapted to abut against the shaft body 451 so as to suppress the opening portion opening movement by more than a predetermined amount of the portion 433 of the framed panel 404. A rolling roller may be fitted at the portion of the shaft body 451 which is disposed in the elongated hole 461.

A portion 471 of the elongated hole 461 formed in the linear motion supporting portion 453 extends in the direction X toward the interior or exterior of the building. The shaft body 451 disposed in the linear motion supporting portion 453 is in a state of being linearly movable in the direction X toward the interior or exterior of the building so as to move toward the end portion 454 on the basis of the air current directed toward the direction X2 toward the interior of the building and to move toward the end portion 456 on the basis of the air current directed toward the direction X1 toward the exterior of the building. In a state in which the portion 433 of the framed panel 404 is located at the end portion 456 of the linear motion supporting portion 453, as shown in FIG. 43 the framed panel 404 is brought to a standstill by maintaining a balance owing to its own weight. The framed panel 404 in such a standstill state is in a state of being movable for opening the opening portion and movable for closing the opening portion on the basis of the air current. The position in which the framed panel 404 is brought to a standstill, as shown in FIG. 4, is set to the opening portion open position in this embodiment.

A line 475 shown in FIG. 7 and extending along a portion 472 of the elongated hole 461 formed in the end side supporting portion 455 is the locus of the axis of the shaft body 451 which moves in the portion 472. Such a line 475 may be a straight line or a curved line, and in the case of a curved line the line 475 may be concave or convex toward the upper side. The line 475 is inclined upward from the building exterior 407 side toward the building interior 408 side with respect to a line 476 shown in FIG. 7 and extending in the direction X toward the interior or exterior of the building. One end on the building interior 408 side of the portion 472 is located higher than the other end of the portion 472 continuous to the portion 471. For example, in a case where the line 475 is a curved line which is concave toward the upper side, a closing movement resisting force of an opening portion based on the self weight of the framed panel 404, which resists an opening portion closing movement force based on the air current and applied to the portion 433 of the framed panel 404 located at the end side supporting portion 455, increases gradually as the position of the shaft body 451 shifts from the other end side (the end portion side on the building exterior 407 side) of the end side supporting portion 455 to the one end side (the end portion side on the building interior 408 side) thereof. The end side supporting portion 455 is adapted to impart the closing movement resisting force of the opening portion to the portion 433 of the framed panel 404, as described above, thereby making it possible to decelerate the opening portion closing movement of the framed panel 404 immediately before the arrival of the framed panel 404 in the opening portion closed position and to weaken the impact at the time of the closing of the opening portion. In addition, the end side supporting portion 455 is also adapted to impart, for the opening portion opening, an opening portion opening movement force based on the self weight of the framed panel 404 to the portion 433 of the framed panel 404 located at that end side supporting portion 455, thereby allowing the opening portion opening operation of the framed panel 404 to be performed smoothly. For example, in a case where the line 475 is a curved line which is concave toward the upper side, it is possible to weaken the opening portion opening movement force based on the aforementioned self weight as the position of the shaft body 451 shifts from the one end side of the portion 472 to the other end side thereof thereby allowing the opening portion opening operation to be performed more smoothly.

A line 477 shown in FIG. 7 and extending along a portion 473 of the elongated hole 461 formed in the end side supporting portion 457 is the locus of the axis of the shaft body 451 which moves in the portion 473. Such a line 477 may be a straight line or a curved line, and in the ease of a curved line the line 477 may be concave or convex toward the upper side. The line 477 is inclined upward from the building interior 408 side toward the building exterior 407 side with respect to the line 476 extending in the direction X toward the interior or exterior of the building. One end on the building exterior 407 side of the portion 473 is located higher than the other end of the portion 473 continuous to the portion 471. For example, in a case where the line 477 is a curved line which is concave toward the upper side, an opening movement resisting force of an opening portion based on the self weight of the framed panel 404, which resists an opening portion opening movement force based on the air current and applied to the portion 433 of the framed panel 404 located at the end side supporting portion 457, increases gradually as the position of the shaft body 451 shifts from the other end side of the end side supporting portion 457 to the one end side thereof. The end side supporting portion 457 is adapted to impart the opening movement resisting force of the opening portion to the portion 433 of the framed panel 404, as described above, thereby making it possible to decelerate the opening portion opening movement of the framed panel 404 immediately before the arrival of the framed panel 404 in the opening portion fitly-open position shown in FIG. 9 and to prevent the collision of the shaft body 451 against the end face 463. In addition, since the line 477 is inclined upward from the building interior 408 side toward the building exterior 407 side with respect to the line 476, the end side supporting portion 457 is also adapted to impart an opening portion closing movement force based on the self weight of the framed panel 404 to the portion 433 of the framed panel 404 located at that end side supporting portion 457, so as to return the framed panel 404 to the opening portion open position.

A line 481 shown in FIG. 5 and connecting the portion 433 and the center of gravity G2 in the case where the framed panel 404 is in the opening portion closed position is inclined downward toward the building interior 408 with respect to a line 482 extending in the vertical direction V. An angle of inclination θ1 of the line 481 with respect to the line 482 becomes gradually small as the framed panel 404 approaches the opening portion open position by the opening portion opening movement and the angle of inclination θ1 becomes 0 degree when the framed panel 404 is disposed in the opening portion open position A line 483 shown in FIG. 4 and connecting the portion 433 and the center of gravity G2 of the framed panel 404 in the opening portion open position becomes parallel to the line 482 extending in the vertical direction V. In a case where the line 481 is inclined downward toward the building interior 408 side with respect to the line 482, the opening portion opening movement force based on the self weight of the framed panel 404 is imparted to the framed panel 404, and in a case where the angle of inclination θ1 has become 0 degree, the aforementioned opening portion opening movement force based on the self weight ceases to be generated. On the other hand, a line 484 shown in FIG. 9 and connecting the portion 433 of the framed panel 404 and the center of gravity G2 of the framed panel 404 in the case where the framed panel 404 is in the opening portion fully-open position is inclined downward toward the building exterior 407 side with respect to the line 482 extending in the vertical direction V. An angle of inclination θ2 of the line 484 with respect to the line 482 becomes gradually small as the framed panel 404 approaches the opening portion open position by the opening portion closing movement, and when the framed panel 404 is disposed in the opening portion open position, the angle of inclination θ2 becomes 0 degree in the same way as described above. In a case where the line 484 is inclined downward toward the building exterior 407 side with respect to the line 482, the opening portion closing movement force based on the self weight is imparted to the framed panel 404, and when the angle of inclination θ2 has become 0 degree, the aforementioned opening portion closing movement force based on the self weight ceases to be generated.

The engaging means 435 has an engaging member 465 constituted by an L-shaped lever fitted rotatably to the bottom rail 423. As such an engaging member 465 is rotatively operated in the opening portion closed state, the engaging member 465 abuts against the lower frame 413 on the building exterior 408 side and is thereby adapted to allow the framed panel 404 to engage the window frame 402. In addition, as the engaging member 465 is rotatively operated in the opposite direction to that of the aforementioned rotative operation, the engaging member 465 is moved away from the lower frame 413 and is thereby adapted to allow the framed panel 404 to be disengaged from the window frame 402.

A description will be given of the window opening and closing operation by the above-described natural ventilation window 401. First the opening portion opening movement of the framed panel 404 which is in the opening portion closed position shown in FIG. 5 is allowed by canceling the engagement between the framed panel 404 and the window frame 402 by the engaging means 435. When the engagement by the engaging means 435 is canceled, a rotational moment in the R5 direction toward the opening portion open position is imparted to the portion 433 of the framed panel 404 in that opening portion closed position since the portion 433 is located on the building exterior 407 side relative to the center of gravity G2 in the direction X toward the interior or exterior of the building. Moreover, since the shaft body 451 is in the portion 472, the shaft body 451 moves along the portion 472 on the basis of the self weight of the framed panel 404, and the portion 433 of the framed panel 404 hence starts to move in the direction X1 toward the exterior of the building, so that the framed panel 404 starts the opening portion opening movement. In conjunction with the rotation of the portion 433 in the R5 direction, the shaft body 441 is lowered along the groove 443 while generating rotation in the R4 direction. The rotational moment in the R5 direction toward the opening portion open position, which is imparted to the framed panel 404, decreases gradually since the angle of inclination θ1 becomes gradually small as the framed panel 404 approaches the opening portion open position. Also when the shaft body 451 has shifted from the portion 472 to the portion 471, as shown in FIG. 8, the opening portion opening movement force based on the self weight is imparted to the framed panel 404, so that framed panel 404 keeps on continuing the opening portion opening movement. When the portion 433 reaches the opening portion open position by the opening portion opening movement of the framed panel 404, the portion 433 and the center of gravity G2 are located on the identical line extending in the vertical direction V. Consequently, the opening portion opening movement force based on the self weight of the framed panel 404 ceases to be generated, so that the framed panel 404 is brought to a standstill. Since the rotational moment in the R5 direction thus decreases gradually, it is possible to prevent the rapid opening of the opening portion by the framed panel 404. On the other hand, when the framed panel 404 is conversely moved gradually from the opening portion open position toward the opening portion closed position, the rotational moment in the R5 direction toward the opening portion open position, which is imparted to the framed panel 404, increases gradually so as to resist the aforementioned movement of the framed panel 404. Hence, it is possible to prevent the rapid closing of the opening portion. Moreover, since the end side supporting portion 455 is provided, when the portion 433 is located in the opening portion closed position or in a position in the vicinity thereof, it is possible to smoothly effect the starting of the opening portion opening movement of the framed panel 404 and to prevent the rapid closing of the opening portion.

In the case where the framed panel 404 is disposed in the opening portion open position, when the building exterior 407 side assumes a positive pressure and the building interior 408 side assumes a negative pressure with respect to the framed panel 404 owing to the air current, an opening portion closing movement force based on the air current is imparted to the framed panel 404. Hence, that framed panel 404 is moved to close the opening portion on the basis of the air current, thereby decreasing the flow rate of air from the building exterior 407 into the building interior 408. On the other hand, when the building exterior 407 side assumes a negative pressure and the building interior 408 side assumes a positive pressure with respect to the framed panel 404 owing to the air current, an opening portion opening movement force based on the air current is imparted to the framed panel 404. Hence, that framed panel 404 is moved to open the opening portion on the basis of the air current, thereby increasing the flow rate of air from the building interior 408 to the building exterior 407. When the opening portion opening movement force or the opening portion closing movement force based on the air current ceases to be generated, the framed panel 404 is returned to the opening portion open position and is brought to a standstill, as described above.

When the shaft body 451 is located in the portion 473, the opening movement resisting force of the opening portion, which resists the opening portion opening movement force, is imparted to the framed panel 404, so that the opening portion opening movement of the framed panel 404 toward the opening portion fully-open position is decelerated, and the framed panel 404 is brought to a standstill. When the opening portion opening movement force based on the air current ceases to be generated, the framed panel 404 whose portion 433 is at the end side supporting portion 457 is returned to the opening portion open position and is brought to a standstill.

As for the framed panel 404 in the opening portion open position, since the angles of inclination θ1 and θ2 are 0 degree, as a small opening portion opening movement force and opening portion closing movement force based on the air current is imparted, the opening portion opening movement and the opening portion closing movement are generated. As the framed panel 404 gradually moves away from the opening portion open position, the opening movement resisting force of the opening portion and the closing movement resisting force of the opening portion based on the self weight of the framed panel 404 are generated, so that the opening portion opening movement and the opening portion closing movement cannot be generated in the framed panel 404 by the small opening portion opening movement force and opening portion closing movement force based on the air current. Thus, even with a small air current, the opening and closing movement of the framed panel 404 can be generated on the basis of that air current, and it is also possible to prevent the rapid opening portion opening and opening portion closing by the framed panel 404. It should be noted that, with the above-described natural ventilation window 401, the engaging member 465 fitted to the framed panel 404 is pulled from building interior 408 side by a manual operation to dispose the framed panel 404 in the opening portion closed position, and that engaging member 465 is engaged with the lower frame 413, thereby maintaining the closed state of the opening portion 403.

The natural ventilation window 401 in accordance with this embodiment includes the supporting mechanism 432 for supporting the portion 431 on the top rail 422 side of the framed panel 404, as well as the supporting mechanism 434 for supporting the other portion 433 of the framed panel 404 which is located below the portion 431 and above the center of gravity of the framed panel 404 in the case where the framed panel 404 is in the opening portion closed position and on the building exterior 407 side relative to the center of gravity G2 of the framed panel 404. In substitution of these, the natural ventilation window 401 may include, for example, a first supporting mechanism for supporting a portion on the bottom rail 423 side of the framed panel 404 liftably and rotatably about a horizontal axis, as well as a second supporting mechanism for supporting another portion of the framed panel 404 located above that portion on the bottom rail 423 side of the framed panel 404, movably in the direction X toward the interior or exterior of the building and rotatably about a horizontal axis. Furthermore, the other portion of the framed panel 404 may be disposed so as to be located above the center of gravity G2 of the framed panel 404 and to be located on the building interior 408 side relative to that center of gravity G2 in the case where the framed panel 404 is in the opening portion closed position. The above- and below-described operational effects can also be demonstrated by the natural ventilation window 401 having such first and second supporting mechanisms.

According to the above-described natural ventilation window 401, the natural ventilation window 401 is comprised of the window frame 402 which is installed in the building; the framed panel 404 disposed in the opening portion 403 defined by the window frame 402; and the opening/closing means 406 for opening and closing the opening portion 403 on the basis of an air current. The opening/closing means 406 includes the supporting mechanism 432 for supporting the portion 431 on the top rail 422 side of the trained panel 404 liftably and rotatably about the horizontal axis S4, as well as the supporting mechanism 434 for supporting the other portion 433 of the framed panel 44, which is located below the portion 431, movably in the direction X toward the interior or exterior of the building and rotatably about the horizontal axis S5. The other portion 433 of the framed panel 404 is disposed so as to be located above the center of gravity G2 of the framed panel 404 and to be located on the building exterior 407 side with respect to that center of gravity G2 when the framed panel 404 is in the opening portion closed position. The supporting mechanism 434 includes the shaft body 451 serving as a supported member formed in the other portion 433 of framed panel 404, as well as the support member 452 which is fitted to the window frame 402 so as to support the shaft body 451. The support member 452 includes the following: the linear motion supporting portion 453 for supporting the shaft body 451 linearly movably in the direction X toward the interior or exterior of the building and rotatably about the horizontal axis S5; and at least one of the end side supporting portion 455 connected to the end portion 454 close to the building interior 408 side of the linear motion supporting portion 453 and adapted to support the shaft body 451 movably in the direction intersecting to the direction X toward the interior or exterior of the building and rotatably about the horizontal axis S5, so as to displace the other portion 433 of the framed panel 404 upward at the time of movement of that other portion 433 toward the direction X2 toward the interior of the building, and to displace the other portion 433 of the framed panel 404 downward at the time of movement of that other portion 433 toward the direction X1 toward the exterior of the building, and the end side supporting portion 457 connected to the end portion 456 close to the building exterior 407 side of the linear motion supporting portion 453 and adapted to support the shaft body 451 movably in the direction intersecting to the direction X toward the interior or exterior of the building and rotatably about the horizontal axis S5, so as to displace the other portion 433 of the framed panel 404 downward at the time of movement of that other portion 433 toward the direction X2 toward the interior of the building, and to displace the other portion 433 of the framed panel 404 upward at the time of movement of that other portion 433 toward the direction X1 toward the exterior of the building. The support member 452 in this embodiment includes both the end side supporting portion 455 and the end side supporting portion 457. Therefore, it is possible to lighten the opening portion closing movement, based on the air current, of the framed panel 404 on the opening portion open position side and to make heavy the opening portion closing movement, based on the air current, of the framed panel 404 on the opening portion closed position side. Thus, it is possible to suitably provide ventilation by the opening/closing movement, based on the air current, of the framed panel 404 on the opening portion open position side. Moreover, in the case where the end side supporting portion 457 close to the building exterior 407 side is provided, it is possible to prevent the rapid opening portion opening movement of the framed panel 404 on the opening portion open position side. In the ease where the end side supporting portion 455 close to the building interior 408 side is provided, it is possible to prevent the rapid opening portion closing movement of the framed panel 404 on the opening portion closed position side. In addition, the supporting mechanism 432 liftably supports the portion 431 on the top rail 422 side of the framed panel 404, while the supporting mechanism 434 supports the other portion 433 of the framed panel 404 movably in the direction X toward the interior or exterior of the building. Hence, it is possible to cause the framed panel 404 to project toward only the building exterior 407 side when the opening portion 403 is opened.

According to the natural ventilation window 401, the other portion 433 of the framed panel 404 in the opening portion open position and the center of gravity G2 of that framed panel 404 are respectively located on the identical line extending in the vertical direction V. Therefore, it is possible to balance the framed panel 404 in the opening portion open position without needing to install a weight or the like on the framed panel 404, and it is possible to stop the opening portion opening movement of the framed panel 404 without using a stopper or the like. Moreover, it is possible to lighten the opening/closing movement, based on the air current, of the framed panel 404 in the opening portion open position or its vicinity.

According to the natural ventilation window 401, the supporting mechanism 432 is adapted to support the portion 431 on the top rail 422 side of the framed panel 404, while the supporting mechanism 434 is adapted to support the other portion 433 of the framed panel 404 so as to be located below the portion 431 on the top rail 422 side of the framed panel 404 and to be located on the building exterior 407 side relative to the center of gravity G2 of the framed panel 404 in the opening portion closed position. Therefore, the opening portion 403 can be closed and opened particularly in correspondence with an increase and decrease of the air current directed from the building exterior 407 toward the building interior 408. However, the supporting mechanism 432, for example, may be adapted to support a portion on the bottom rail 423 side of the framed panel 404, and the supporting mechanism 434 may be adapted to support another portion of the framed panel 404 so as to be located above that portion on the bottom rail 423 side of the framed panel 404 and to be located on the building interior 408 side relative to the center of gravity G2 of the framed panel 404 in the opening portion closed position. In such a case, the opening portion 403 can be closed and opened particularly in correspondence with an increase and decrease of the air current directed from the building interior 408 toward the building exterior 407.

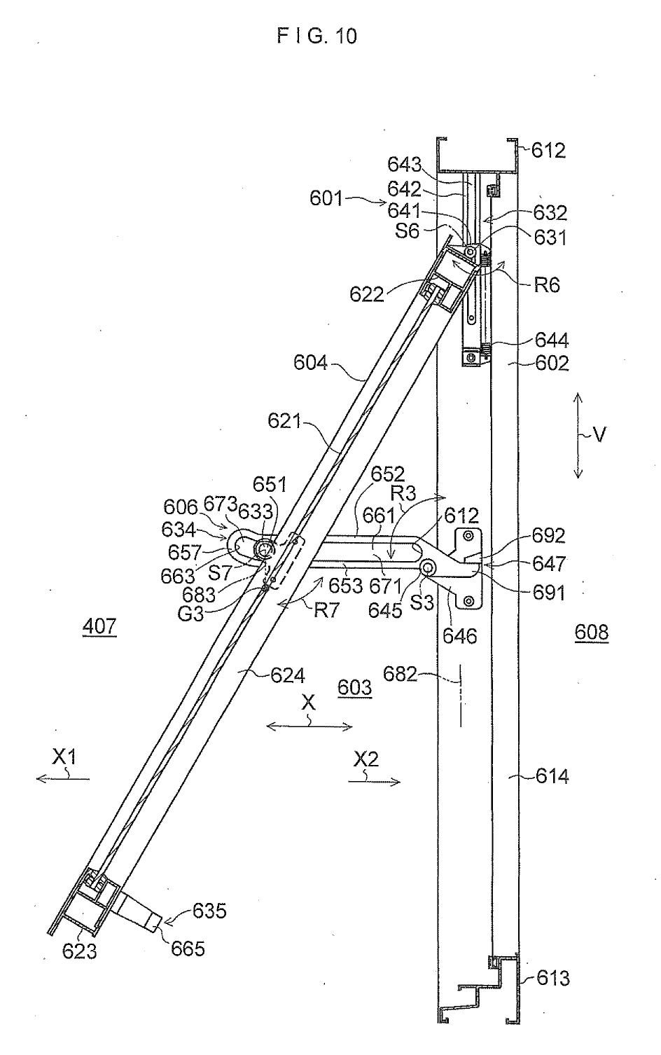

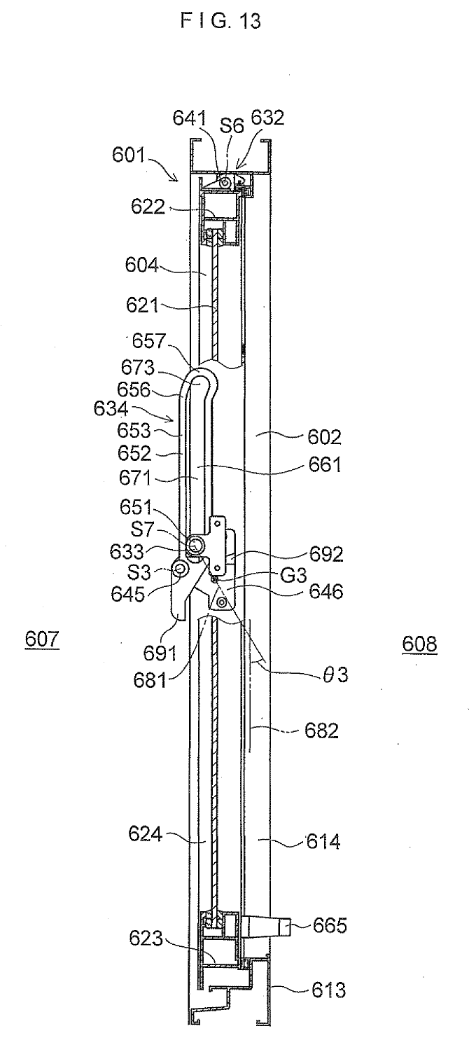

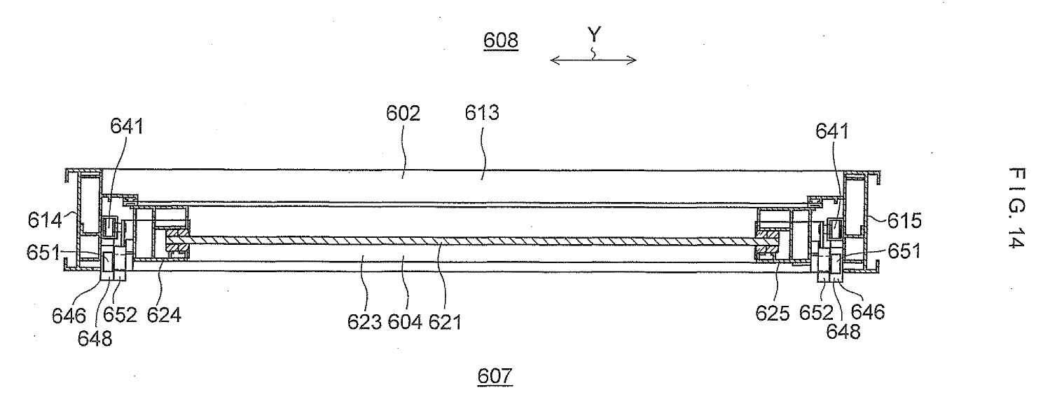

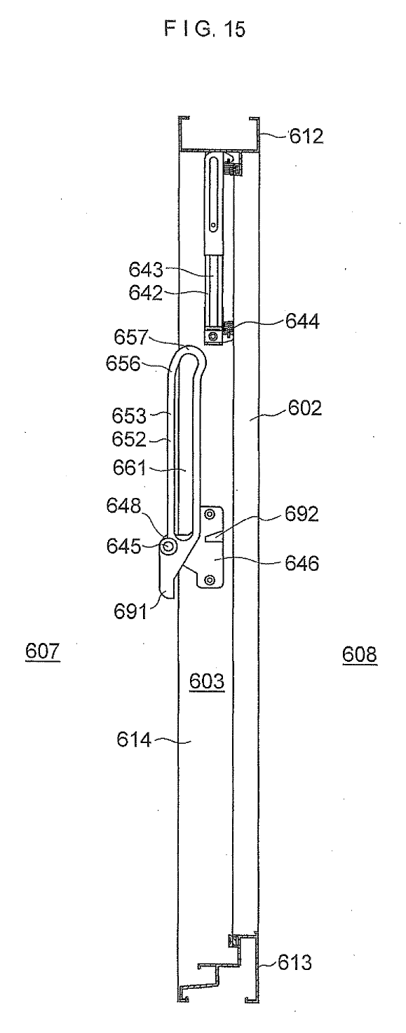

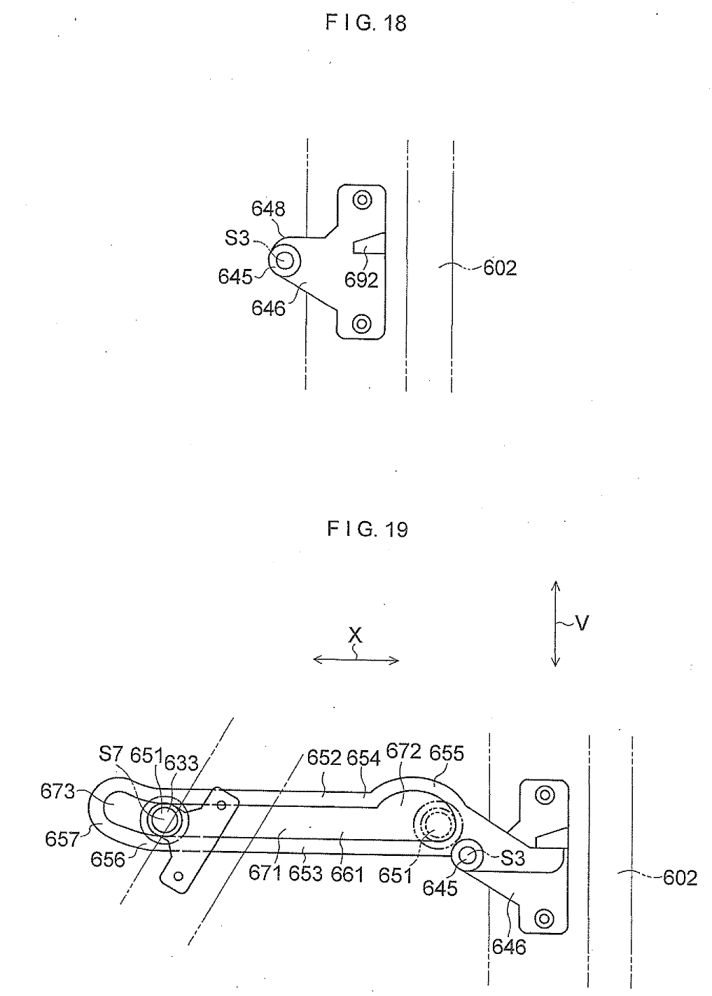

In FIGS. 10 to 19, a natural ventilation window 601 in accordance with still another embodiment is comprised of a window frame 602 which is installed in a building (not shown); a framed panel 604 disposed in an opening portion 603 defined by the window frame 602; and an opening/closing means 606 for opening and closing the opening portion 603 on the basis of an air current. The natural ventilation window 601 is adapted to open the opening portion 603, as shown in FIG. 10, by the opening portion opening movement of the framed panel 604 moving toward a building exterior 607 side, and is adapted to close the opening portion 603, as shown in FIGS. 13 and 14, by the opening portion closing movement of the framed panel 604 moving toward a building interior 608 side.

The window frame 602 has an upper frame 612, a lower frame 613, and a pair of vertical frames 614 and 615. A seal member for abutting against the framed panel 604 is fitted to those portions of the upper frame 612, the lower frame 613, and the vertical frames 614 and 615 which abut against the framed panel 604.

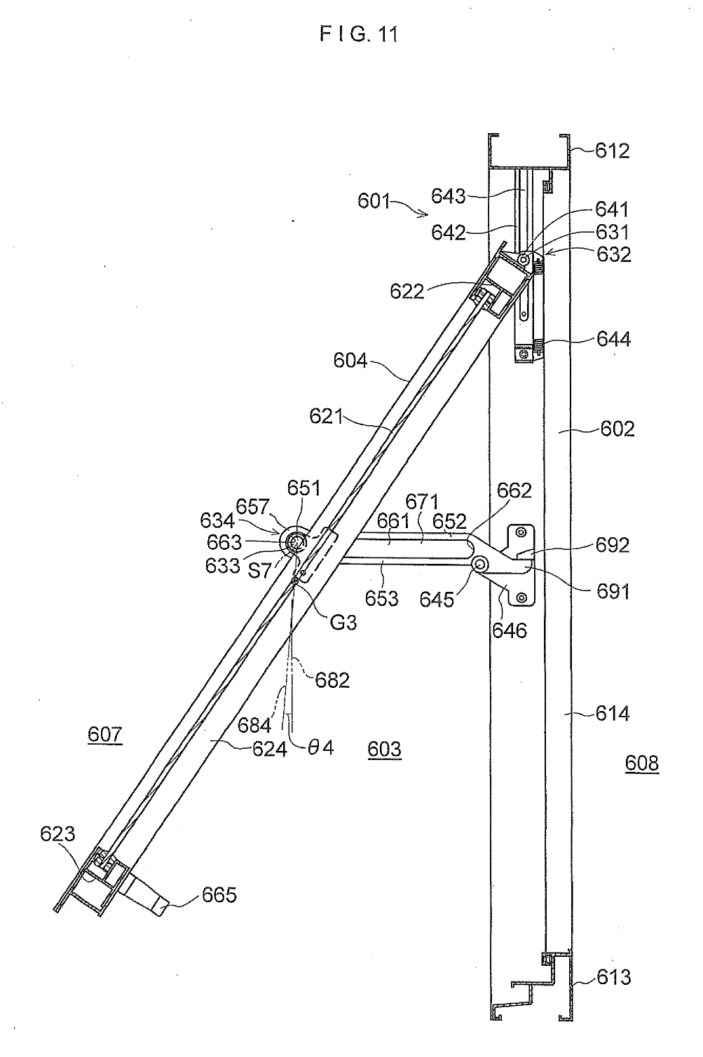

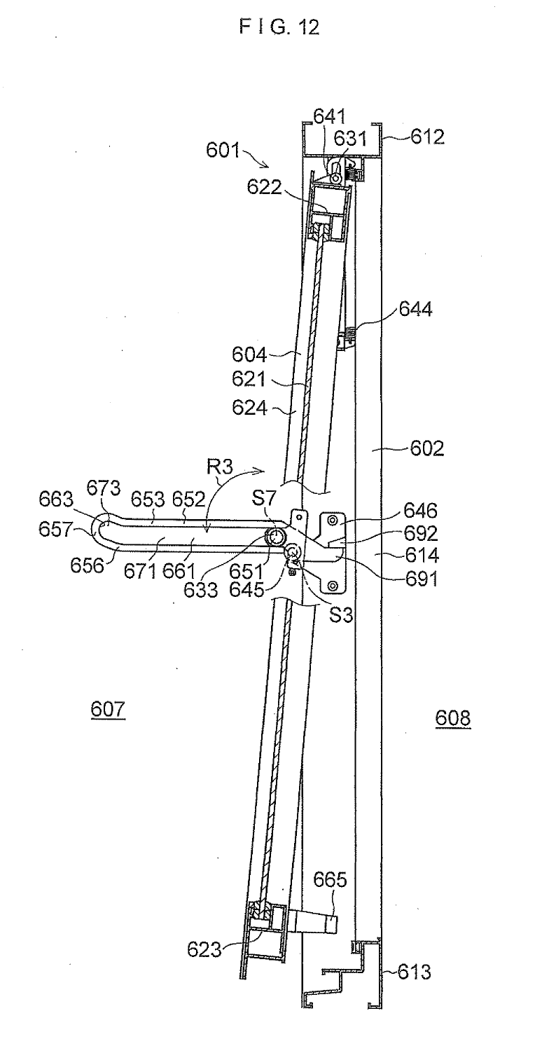

The framed panel 604 is fitted to the window frame 602 by means of the opening/closing means 606 so that the opening portion 603 can be freely opened and closed. The framed panel 604 has a rectangular framed panel body 621 constituted by a glass plate or the like, a top rail 622, a bottom rail 623, and a pair of stiles 624 and 625. The peripheries of the framed panel body 621 are covered by the top rail 622, the bottom rail 623, and the pair of stiles 624 and 625. Portions of the stiles 624 and 625, into which below-described shaft bodies 651 serving as members to be supported are respectively fitted, project to the building exterior 607 side with respect to the framed panel body 621 in this embodiment. The framed panel 604 assumes a stationary state in the opening portion open position, and is adapted to narrow the opening portion 603, as shown in FIG. 12, by the opening portion closing movement based on the air current and to expand the opening portion 603, as show in FIG. 11, by the opening portion opening movement based on the air current.

The opening/closing means 606 includes a supporting mechanism 632 for supporting a portion 631 on the top rail 622 side of the framed panel 604 liftably in the vertical direction V and rotatably about a horizontal axis S6 in an R6 direction; a supporting mechanism 634 for supporting another portion 633 of the framed panel 604, which is located below the portion 631, movably in the direction X toward the interior or exterior of the building and rotatably about a horizontal axis S7 in an R7 direction; and an engaging means 635 for causing the framed panel 604 in the opening portion closed position to engage the window frame 602. The portions 631 and 633 are respectively provided in the stiles 624 and 625. The horizontal axes S6 and S7 extend in the lateral direction Y which is perpendicular to the vertical direction V and the direction X toward the interior or exterior of the building. The direction X toward the interior or exterior of the building in this embodiment is a direction which is parallel to the horizontal direction and is perpendicular to the lateral direction Y, but may also be, for example, a direction which is inclined upward or downward with respect to the horizontal direction (direction within a horizontal plane) from the building interior 608 side toward the building exterior 607 side. The portion 633 is disposed so as to be located above a center of gravity G3 of the framed panel 604 and to be located on the building exterior 607 side with respect to that center of gravity G3 when the framed panel 604 is in the opening portion closed position.

The supporting mechanism 632 includes a shaft body 641 which is fitted in the respective one of the portion 631 of the stile 624 and the portion 631 of the stile 625; a guide member 642 which is fitted to the respective one of the vertical frames 614 and 615 so as to linearly guide the shaft body 641 in the vertical direction V and which extends in the vertical direction V; and a spring 644 serving as an urging member for resiliently urging the portion 631 downward with respect to the window frame 602, so as to impart a moving force in the opening portion opening direction to the framed panel 604. It should be noted that although in this embodiment the supporting mechanism 632 has the spring 644, this spring 644 may be omitted.

The guide member 642 has a U-shaped cross section so as to form a groove 643 extending in the vertical direction V. The shaft body 641 is disposed in the groove 643 linearly movably in the vertical direction V and rotatably about the horizontal axis S6. The guide member 642 is formed so as to be of a length identical to or longer than the distance whereby the shaft body 641 moves linearly in the vertical direction V in conjunction with the opening or closing movement of the framed panel 604. A rolling roller may be fitted at the portion of the shaft body 641 which is disposed in the groove 643. It should be noted that, in order to prevent the shaft body 641 from being lowered more than the position of the shaft body 641 in the opening portion open state, shown in FIG. 10, with respect to the guide member 642, the supporting mechanism 632 may further include a stopper for abutting against the shaft body 641 at that position. In conjunction with the opening portion opening movement and the opening portion closing movement of the framed panel 604, the shaft body 641 is raised and lowered in the vertical direction V with respect to the guide member 642 and is rotated about the horizontal axis S6 as an axis with respect to that guide member 642.

As shown in FIG. 13, the portion 631 having the horizontal axis S6 as its center is located above the center of gravity G3 of the framed panel 604 in the opening portion closed position. The portion 631 in this embodiment is located slightly on the building interior 608 side with respect to the aforementioned center of gravity G3 in the direction X toward the interior or exterior of the building. Such a supporting mechanism 632 is adapted to support the portion 631 linearly movably in the vertical direction V and rotatably about the horizontal axis S6.

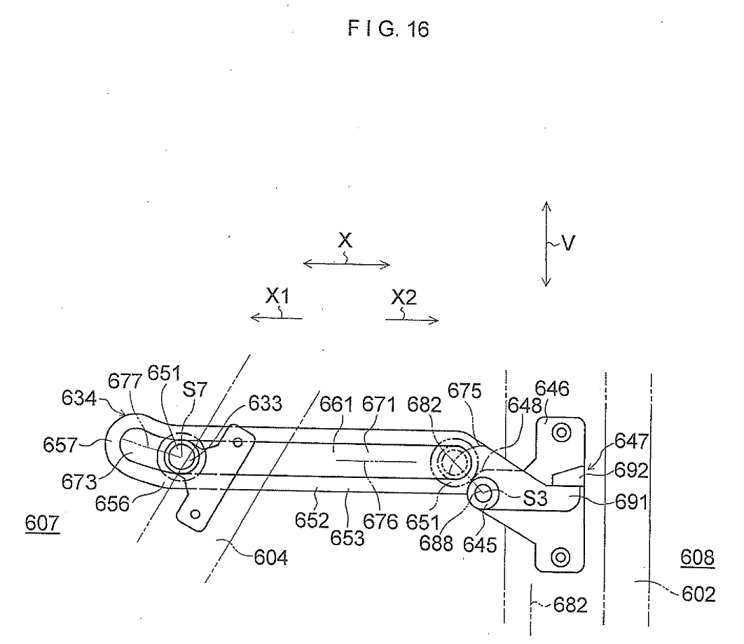

The supporting mechanism 634 includes the following: the shaft body 651 serving as a supported member formed in the respective one of the portion 633 of the stile 624 and the portion 633 of the stile 625 and extending in the lateral direction Y; a support member 652 for supporting the shaft body 651 linearly movably in the direction X toward the interior or exterior of the building and rotatably about the horizontal axis S7; a rotating shaft 645 which is located below the shaft body 651 in a state of being supported by the support member 652 linearly movably in the direction X toward the interior or exterior of the building and on the building interior 608 side, and which connects the support member 652 to the window frame 602 rotatably about the horizontal axis S3 in the R3 direction: a guide member 646 which is fitted to the window frame 602 and abuts against the shaft body 651 located close to the building interior 608 side, so as to upwardly guide the shaft body 651 on the basis of the linear motion of that shaft body 651 toward the direction X2 toward the interior of the building and to downwardly guide the shaft body 651 on the basis of the linear motion of the shaft body 651 toward the direction X1 toward the exterior of the building; and a holding mechanism 647 for holding the angle of rotation of the support member 652 in the state of supporting the shaft body 651 linearly movably in the direction X toward the interior or exterior of the building, as shown in FIGS. 10 and 16.

In the case where the framed panel 604 is in the opening portion closed position, as shown in FIG. 13, the shaft body 651 and the portion 633 having the horizontal axis S7 as their center are located above the center of gravity G3 of the framed panel 604 and are located on the building exterior 607 side with respect to that center of gravity G3. In the case where the framed panel 604 is in the opening portion open position, as shown in FIG. 10, the portion 633 and the shaft body 651 as well as the center of gravity G3 of the framed panel 604 are respectively located on an identical line extending in the vertical direction V.

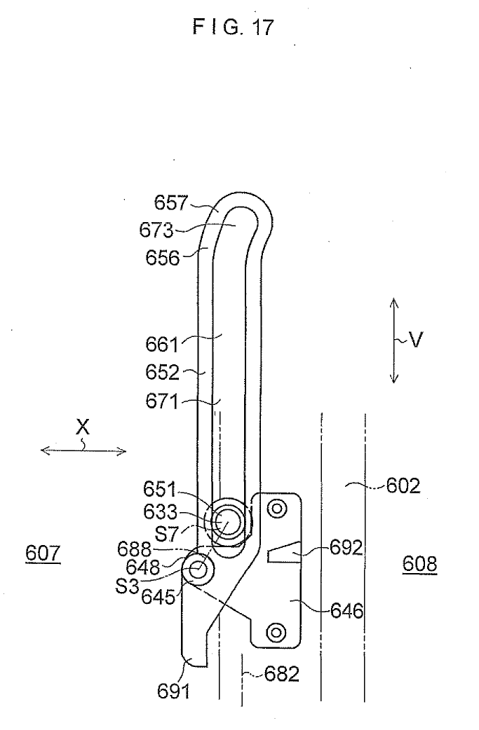

As shown in FIGS. 16 and 17, for instance, the support member 652 includes a linear motion supporting portion 653 for supporting the shaft body 651 linearly movably in the direction X toward the interior or exterior of the building and rotatably about the horizontal axis S7 in the R7 direction, as well as an end side supporting portion 657 which is close to the building exterior 607 side and is connected to an end portion 656 close to the building exterior 607 side of the linear motion supporting portion 653, the end side supporting portion 657 being adapted to support the shaft body 651 movably in a direction intersecting to the direction X toward the interior or exterior of the building and rotatably about the horizontal axis S7 in the R7 direction, so as to displace the portion 633 of the framed panel 604 downward with respect to the vertical direction V at the time of movement of that portion 633 toward the direction X2 toward the interior of the building, and to displace the portion 633 of the framed panel 604 upward with respect to the vertical direction V at the time of movement of that portion 633 toward the direction X1 toward the exterior of the building.

The linear motion supporting portion 653 and the end side supporting portion 657 in cooperation with each other form an elongated hole or a slit, i.e., an elongated hole 661 in this embodiment, for guiding the shaft body 651 in the direction X toward the interior or exterior of the building and in a direction intersecting to the direction X toward the interior or exterior of the building. The shaft body 651 is disposed in the elongated hole 661 linearly movably in the direction X toward the interior or exterior of the building and rotatably about the horizontal axis S7 in the R7 direction. An end face 662 on the building interior 608 side of the elongated hole 661 is disposed so as to be located above the rotating shaft 645 and on the building exterior 607 side in the case where the framed panel 604 is in the opening portion open position shown in FIG. 10, and the end face 662 is disposed so as to be located above the rotating shaft 645 and on the building interior 608 side in the case where the framed panel 604 is in the opening portion closed position shown in FIG. 13. The end face 662 is adapted to abut against the shaft body 651 so as to suppress the opening portion closing movement by more than a predetermined amount of the portion 633 of the framed panel 604. An end face 663 on the building exterior 607 side of the elongated hole 661 is adapted to abut against the shaft body 651 so as to suppress the opening portion opening movement by more than a predetermined amount of the portion 633 of the framed panel 604. A rolling roller may be fitted at the portion of the shaft body 651 which is disposed in the elongated hole 661.

A portion 671 of the elongated hole 661 formed in the linear motion supporting portion 653 extends in the direction X toward the interior or exterior of the building. The shaft body 651 in the state of being disposed in the linear motion supporting portion 653 is linearly movable in the direction X toward the interior or exterior of the building so as to move toward the building interior 608 side of the linear motion supporting portion 653 on the basis of the air current directed toward the direction X2 toward the interior of the building and to move toward the building exterior 607 side on the basis of the air current directed toward the direction X1 toward The exterior of the building. In a state in which the portion 633 of the framed panel 604 is located at the end portion 656 of the linear motion supporting portion 653, as shown in FIG. 10, the framed panel 604 is brought to a standstill by maintaining a balance owing to its own weight. The framed panel 604 in such a standstill state is in a state of being movable for opening the opening portion and movable for closing the opening portion on the basis of the air current. The position in which the framed panel 604 is brought to a standstill, as shown in FIG. 10, is set to the opening portion open position in this embodiment.

A line 677 shown in FIG. 16 and extending along a portion 673 of the elongated hole 661 formed in the end side supporting portion 657 is the locus of the axis of the shaft body 651 which moves in the portion 673. Such a line 677 may be a straight line or a curved line, and in the case of a curved line the line 677 may be concave or convex toward the upper side. The line 677 is inclined upward from the building interior 608 side toward the building exterior 607 side with respect to a line (straight line) 676 extending in the direction X toward the interior or exterior of the building. One end on the building exterior 607 side of the portion 673 is located higher than the other end of the portion 673 continuous to the portion 671. For example, in a case where the line 677 is a curved line which is concave toward the upper side, an opening movement resisting force of an opening portion based on the self weight of the framed panel 604, which resists an opening portion opening movement force based on the air current and applied to the portion 633 of the framed panel 604 located at the end side supporting portion 657, increases gradually as the position of the shaft body 651 shifts from the other end side of the end side supporting portion 657 to the one end side thereof. The end side supporting portion 657 is adapted to impart the opening movement resisting force of the opening portion to the portion 633 of the framed panel 604, as described above, thereby making it possible to decelerate the opening portion opening movement of the framed panel 604 immediately before the arrival of the framed panel 604 in the opening portion fully-open position shown in FIG. 11 and to prevent the collision of the shaft body 651 against the end face 663. In addition since the line 677 is inclined upward from the building interior 608 side toward the building exterior 607 side with respect to the line 676, the end side supporting portion 657 is also adapted to impart an opening portion closing movement force based on the self weight of the framed panel 604 to the portion 633 of the framed panel 604 located at that end side supporting portion 657, so as to return the framed panel 604 to the opening portion open position.

It should be noted that the support member 652 may further include an end side supporting portion 655 which is close to the building interior 608 side and is connected to an end portion 654 close to the building interior 608 side of the linear motion supporting portion 653, as shown in FIG. 19. The end side supporting portion 655 has a more enlarged portion 672 of the elongated hole 661 than the portion 671 of the elongated hole 661 formed in the linear motion supporting portion 653 and is adapted to support the shaft body 651 in that enlarged portion 672.

The guide members 646 are respectively fitted to the vertical frames 614 and 615 so as to abut against the shaft body 651 before or simultaneously as the rotation in the R3 direction based on the linear motion of the shaft body 651 toward the direction X2 toward the interior of the building is generated in the support member 652. The guide member 646 has a circular are shaped guide surface 648 for abutting against the shaft body 651.

The rotating shaft 645 constitutes a rotational axis of the support member 652 and is disposed eccentrically with respect to the shaft body 651 in the state of abutting against the end face 662, as shown in FIG. 12. A locus of rotation 675 which is shown by using a line in FIG. 16 and which has as its axis of rotation the rotating shaft 645 of the shaft body 651 in the state of abutting against the end face 662 is directed upward while depicting a circular arc from the building exterior 607 side toward the building interior 608 side. In the state in which the framed panel 604 is disposed in the opening portion closed position, the shaft body 651 is lifted up by the guide member 646 and is located in the uppermost position. When a line 688 connecting the shaft body 651 and the rotating shaft 645 is inclined toward the building exterior 607 side with respect to a line (straight line) 682 extending in the vertical direction V, a rotating force in the R3 direction toward the building exterior 607 side, which is based on the self weight of the framed panel 604, is generated in the support member 652, so that it is possible to impart an impetus to the initial opening portion opening movement of the framed panel 604. In addition, since the rotating force in the R3 direction toward the building exterior 607 side is generated, it is possible to decelerate the opening portion closing movement force of that framed panel 604 immediately before the closing of the opening portion 603 by the framed panel 604, thereby making it possible to weaken the impact at the time of the closing of the opening portion. When the line 688 is inclined toward the building interior 608 side with respect to the line 682, a rotating force in the R3 direction toward the building interior 608 side, which is based on the self weight of the framed panel 604, is generated in the support member 652. This rotating force causes the framed panel 604 to effect the so-called self lock. The support member 652 is rotated about the rotating shaft 645 in conjunction with the opening portion opening movement and the opening portion closing movement of the framed panel 604. During the opening portion opening, the support member 652 is located in such a manner as to project toward the building exterior 607 side, and during the opening portion closing it is located in such a manner as to extend in the vertical direction V or upward in a direction in which it is inclined toward the building interior 608 side. Thus, particularly during the opening portion closing, the support member 652 can be accommodated without projecting toward either the building exterior 607 side or the building interior 608 side.

That portion of the locus of rotation 675 that is located more on the building exterior 607 side than the line 682 passing through the rotating shaft 645 has a gradually sharp gradient with respect to the line 676 from the building interior 608 side toward the building exterior 607 side, as shown in FIG. 16. The locus of the rotational axis of the rotating shaft 645 located more on the building interior 608 side than the line 682 passing through the rotating shaft 645 extends in the horizontal direction since the rotating shaft 645 is guided by the horizontal plane of the guide member 646.

The holding mechanism 647 has a retained projecting portion 691 which is formed integrally with an end portion on the building interior 608 side of the support member 652, as well as a retaining projecting portion 692 formed on the respective one of the stiles 624 and 625 and adapted to retain the retained projecting portion 691. The retained projecting portion 691 is rotated by the rotation in the R3 direction of the support member 652 about the rotating shaft 645, and abuts against the retaining projecting portion 692 when the support member 652 is disposed at the position shown in FIGS. 10 and 16, whereby this abutment retains that retained projecting portion 691 so as to prohibit the rotation of the support member 652 in the R3 direction by more than a predetermined amount toward the building exterior 607 side. When the rotation of the support member 652 is prohibited by such retention, the support member 652 holds the angle of rotation shown in FIGS. 10 and 16, at which the portion 671 assumes a state in which it extends along the direction X toward the interior or exterior of the building.

A line 681 shown in FIG. 13 and connecting the portion 633 and the center of gravity G3 in the case where the framed panel 604 is in the opening portion closed position is inclined downward toward the building interior 608 with respect to the line 682 extending in the vertical direction V. This angle of inclination θ3 decreases gradually as the framed panel 604 approaches the opening portion open position by the opening portion opening movement, and the angle of inclination θ3 becomes 0 degree when the framed panel 604 is disposed in the opening portion open position. A line 683 shown in FIG. 10 and connecting the portion 633 of the framed panel 604 and the center of gravity G3 of the framed panel 604 in the case where the framed panel 604 is in the opening portion open position becomes parallel to the line 682 extending in the vertical direction V. In a case where the line 681 is inclined downward toward the building interior 608 side with respect to the line 682, the opening portion opening movement force based on the self weight of the framed panel 604 is imparted to the framed panel 604, and in a case where the angle of inclination θ3 has become 0 degree, the opening portion opening movement force in the relationship between the position of the portion 633 and the position of the center of gravity G3 ceases to be generated. On the other hand, a line 684 shown in FIG. 11 and connecting the portion 633 of the framed panel 604 and the center of gravity G3 of the framed panel 604 in the case where the framed panel 604 is in the opening portion fully-open position shown in FIG. 11 is inclined downward toward the building exterior 607 with respect to the line 682 extending in the vertical direction V. This angle of inclination θ4 decreases gradually as the framed panel 604 approaches the opening portion open position shown in FIG. 10 by the opening portion closing movement, and when the framed panel 604 is disposed in the opening portion open position, the angle of inclination θ4 becomes 0 degree in the same way as described above. In a case where the line 684 is inclined downward toward the building exterior 607 side with respect to the line 682, the opening portion closing movement force based on the self weight is imparted to the framed panel 604, and when the angle of inclination θ4 has become 0 degree, the opening portion closing movement force in the relationship between the position of the portion 633 and the position of the center of gravity G3 ceases to be generated.

The engaging means 635 has an engaging member 665 constituted by an L-shaped lever fitted rotatably to the bottom rail 623. As such an engaging member 665 is rotatively operated in the opening portion closed state, the engaging member 665 abuts against the lower frame 613 on the building exterior 608 side and is thereby adapted to allow the framed panel 604 to engage the window frame 602. In addition, as the engaging member 665 is rotatively operated in the opposite direction to that of the aforementioned rotative operation, the engaging member 665 is moved away from the lower frame 613 and is thereby adapted to allow the framed panel 604 to be disengaged from the window frame 602.

A description will be given of the window opening and closing operation by the above-described natural ventilation window 1. First, the opening portion opening movement of the framed panel 604 which is in the opening portion closed position shown in FIG. 13 is allowed by canceling the engagement between the framed panel 604 and the window frame 602 by the engaging means 635. Subsequently, the framed panel 604 is slightly moved so that the line 688 is inclined toward the building exterior 607 side with respect to the line 682 to thereby unlock the aforementioned self lock. When the engagement by the engaging means 635 and the aforementioned self lock are canceled, a rotational moment in the R7 direction toward the opening portion open position is imparted to the portion 633 of the framed panel 604 since the portion 633 is located on the building exterior 607 side relative to the center of gravity G3 in the direction X toward the interior or exterior of the building. Moreover, in conjunction with the lowering of the framed panel 604 on the basis of its self weight, the shaft body 651 abuts against the guide member 646 and moves on the locus of rotation 675 toward the building exterior 607 side, so that the framed panel 604 starts the opening portion opening movement while an impetus is being imparted to the framed panel 604 by being guided by the guide member 646. In conjunction with that opening portion opening movement the support member 652 is also rotated in the R3 direction toward the building exterior 607 side. In conjunction with the rotation of the portion 633 in the R7 direction, the shaft body 641 is lowered along the groove 643 while generating rotation in the R6 direction. The rotational moment in the R7 direction toward the opening portion open position, which is imparted to the framed panel 604, decreases gradually since the angle of inclination θ3 becomes gradually small as the framed panel 604 approaches the opening portion open position. Also when the shaft body 651 linearly moves toward the direction X1 toward the exterior of the building in the portion 671, as shown in FIGS. 10 and 12, the opening portion opening movement force based on the self weight is imparted to the framed panel 604, so that framed panel 604 keeps on continuing the opening portion opening movement until reaching the opening portion open position. When the framed panel 604 reaches the opening portion open position by the opening portion opening movement, the portion 633 and the center of gravity G3 are located on the identical line extending in the vertical direction V. Consequently, the opening portion opening movement force based on the self weight of the framed panel 604 ceases to be generated. Hence, the framed panel 604 is brought to a standstill at the opening portion open position. Since the rotational moment in the R7 direction thus decreases gradually, it is possible to prevent the rapid opening of the opening portion by the framed panel 604. On the other hand, when the framed panel 604 is conversely moved gradually from the opening portion open position toward the opening portion closed position, the rotational moment in the R7 direction toward the opening portion open position, which is imparted to the framed panel 604, i.e., a rotational moment resisting against the opening portion closing movement of the framed panel 604, increases gradually. Hence, it is possible to prevent the rapid closing of the opening portion. Moreover, since the rotating shaft 645, the support member 652, and the guide member 646, in particular, are provided, when the portion 633 is located in the opening portion closed position or in a position in the vicinity thereof, it is possible to smoothly effect the starting of the opening portion opening movement of the framed panel 604 and to prevent the rapid closing of the opening portion.

In the case where the framed panel 604 is disposed in the opening portion open position, when the building exterior 607 side assumes a positive pressure and the building interior 608 side assumes a negative pressure with respect to the framed panel 604 owing to the air current, an opening portion closing movement force based on the air current is imparted to the framed panel 604. Hence, that framed panel 604 is moved to close the opening portion on the basis of the air current, thereby decreasing the flow rate of air from the building exterior 607 into the building interior 608. On the other hand, when the building exterior 607 side assumes a negative pressure and the building interior 608 side assumes a positive pressure with respect to the framed panel 604 owing to the air current, an opening portion opening movement force based on the air current is imparted to the framed panel 604. Hence, that framed panel 604 is moved to open the opening portion on the basis of the air current, thereby increasing the flow rate of air from the building interior 608 to the building exterior 607. When the opening portion opening movement force or the opening portion closing movement force based on the air current ceases to be generated, the framed panel 604 is returned to the opening portion open position and is brought to a standstill, as described above.

When the shaft body 651 is located in the portion 673, the opening movement resisting force of the opening portion, which resists the opening portion opening movement force, is imparted to the framed panel 604, so that the opening portion opening movement of the framed panel 604 toward the opening portion fully-open position shown in FIG. 11 is decelerated. When the shaft body 651 abuts against the end face 663, the opening portion opening movement from the opening portion open position toward the opening portion fully-open position is stopped. When the opening portion opening movement force based on the air current ceases to be generated, the framed panel 604 whose portion 633 is at the end side supporting portion 657 is returned to the opening portion open position and is brought to a standstill.

As for the framed panel 604 in the opening portion open position, since the angles of inclination θ3 and θ4 are 0 degree, as a small opening portion opening movement force and opening portion closing movement force based on the air current is imparted, the opening portion opening movement and the opening portion closing movement are generated. In addition, as the framed panel 604 gradually moves away from the opening portion open position, the opening movement resisting force of the opening portion and the closing movement resisting force of the opening portion based on the self weight of the framed panel 604 are generated, so that the opening portion opening movement and the opening portion closing movement cannot be generated in the framed panel 604 by the small opening portion opening movement force and opening portion closing movement force based on the air current. Thus, even with a small air current, the opening and closing movement of the framed panel 604 can be generated on the basis of that air current, and it is also possible to prevent the rapid opening portion opening and opening portion closing by the framed panel 604. It should be noted that, with the above-described natural ventilation window 601, the engaging member 665 fitted to the framed panel 604 is pulled from building interior 608 side by a manual operation to dispose the framed panel 604 in the opening portion closed position, and that engaging member 665 is engaged with the lower frame 613, thereby maintaining the closed state of the opening portion 603.

According to the above-described natural ventilation window 601, the natural ventilation window 601 is comprised of the window frame 602 which is installed in the building; the framed panel 604 disposed in the opening portion 603 defined by the window frame 602; and the opening/closing means 606 for opening and closing the opening portion 603 on the basis of an air current. The opening/closing means 606 includes the supporting mechanism 632 for supporting the portion 631 on the top rail 622 side of the framed panel 604 liftably and rotatably about the horizontal axis S6 in the R6 direction, as well as the supporting mechanism 634 for supporting the other portion 633 of the framed panel 604, which is located below the portion 631, movably in the direction X toward the interior or exterior of the building and rotatably about the horizontal axis S7 in the R7 direction. The portion 633 of the framed panel 604 is disposed so as to be located above the center of gravity G3 of the framed panel 604 and to be located on the building exterior 607 side with respect to that center of gravity G3 when the framed panel 604 is in the opening portion closed position. The supporting mechanism 634 includes the following: the shaft body 651 formed in the portion 633 of the framed panel 604; the support member 652 for supporting the shaft body 651 linearly movably in the direction X toward the interior or exterior of the building and rotatably about the horizontal axis S7 in the R7 direction; the rotating shaft 645 which is located below the shaft body 651 in the state of being supported by the support member 652 linearly movably in the direction X toward the interior or exterior of the building and on the building interior 608 side, and which connects the support member 652 to the window frame 602 rotatably about the horizontal axis S3 in the R3 direction; the guide member 646 which is fitted to the window frame 602 and abuts against the shaft body 651 located close to the building interior 608 side, so as to upwardly guide the shaft body 651 on the basis of the linear motion of that shaft body 651 toward the direction X2 toward the interior of the building and to downwardly guide the shaft body 651 on the basis of the linear motion of the shaft body 651 toward the direction X1 toward the exterior of the building; and the holding mechanism 647 for holding the angle of rotation of the support member 652 in the state of supporting the shaft body 651 linearly movably in the direction X toward the interior or exterior of the building. Therefore, it is possible to lighten the opening portion closing movement, based on the air current, of the framed panel 604 on the opening portion open position side and to make heavy the opening portion closing movement, based on the air current, of the framed panel 604 on the opening portion closed position side. Thus, it is possible to suitably provide ventilation by the opening/closing movement, based on the air current, of the framed panel 604 on the opening portion open position side. As the closing movement resisting force of the opening portion, which resists the opening portion closing movement of the framed panel 4, is generated by the guiding of the shaft body 651 by the guide member 646, it is possible to prevent the rapid opening portion closing movement of the framed panel 604 on the opening portion closed position side. Moreover, as the support member 652 undergoes rotation toward the building interior 608 side on the basis of the linear motion of the shaft body 651 in the direction X2 toward the interior of the building, the support member 652 projects to neither the building interior 608 side nor the building exterior 607 side in the case where the framed panel 604 is in the opening portion closed position.

According to the above-described natural ventilation window 601, the support member 652 includes the linear motion supporting portion 653 for supporting the shaft body 651 linearly movably in the direction X toward the interior or exterior of the building and rotatably about the horizontal axis S7 in the R7 direction; and the end side supporting portion 657 which is close to the building exterior 607 side and is connected to the end portion 656 close to the building exterior 607 side of the linear motion supporting portion 653, the end side supporting portion 657 being adapted to support the shaft body 651 movably in the direction intersecting to the direction X toward the interior or exterior of the building and rotatably about the horizontal axis S7 in the R7 direction, so as to displace the portion 633 of the framed panel 604 downward at the time of movement of that portion 633 toward the direction X2 toward the interior of the building, and to displace the portion 633 of the framed panel 604 upward at the time of movement of that other portion 633 toward the direction X1 toward the exterior of the building. Therefore, it is possible to prevent the rapid opening portion opening movement of the framed panel 604 on the opening portion open position side at the end side supporting portion 657 on the building exterior 607 side.

According to the natural ventilation window 601, the guide member 646 is fitted to the window frame 602 so as to abut against the shaft body 651 before or simultaneously as the rotation based on the linear motion of the shaft body 651 toward the direction X2 toward the interior of the building is generated in the support member 652. Therefore, it is possible to prevent the closing movement resisting force of the opening portion, which resists the opening portion closing movement force of the framed panel 604, from becoming momentarily excessively large at the portion close to the building interior 608 side of the support member 652.

According to the natural ventilation window 601, the portion 633 of the framed panel 604 in the opening portion open position and the center of gravity G3 of that framed panel 604 are respectively located on the identical line extending in the vertical direction V. Therefore, it is possible to balance the framed panel 604 in the opening portion open position without needing to install a weight or the like on the framed panel 604, and it is possible to stop the movement of the framed panel 604 toward the opening portion opening direction without using a stopper or the like. Moreover, it is possible to lighten the opening/closing movement, based on the air current, of the framed panel 604 in the opening portion open position or its vicinity.

1. A natural ventilation window comprising: a framed panel; and opening/closing means for causing said framed panel to open and close an opening portion of a building on the basis of an air current, wherein said opening/closing means includes a first supporting mechanism for supporting a portion on one side of either a top rail or a bottom rail of said framed panel liftably and rotatably about a horizontal axis and a second supporting mechanism for supporting another portion of said framed panel located below or above said portion, movably in a direction toward an interior or exterior of the building and rotatably about the horizontal axis, said another portion being disposed so as to be located above a center of gravity of said framed panel in an opening portion fully-closed position and to be located on one side of either the building interior or the building exterior with respect to the center of gravity.

2. The natural ventilation window according to claim 1, wherein said first supporting mechanism is adapted to support the portion on one side of either the top rail or the bottom rail of said framed panel linearly movably in a vertical direction.

3. The natural ventilation window according to claim 1, wherein said second supporting mechanism is adapted to support said another portion of said framed panel linearly movably in a horizontal direction.

4. The natural ventilation window according to claim 1, wherein said another portion of said framed panel in an opening portion fully-open position and the center of gravity of that framed panel are respectively located on an identical line extending in the vertical direction.

5. The natural ventilation window according to claim 1, wherein said opening/closing means further includes an engaging member for causing said framed panel to engage a window frame defining the opening portion, so as to maintain a state of the opening portion fully closed by said framed panel.

6. The natural ventilation window according to claim 1, wherein said first supporting mechanism is adapted to liftably support a portion on a top rail side of said framed panel, and said another portion of said framed panel is disposed so as to be located below the portion on the top rail side of said framed panel and to be located on the building exterior side relative to the center of gravity of said framed panel in the opening portion fully-closed position.

7. The natural ventilation window according to claim 1, wherein said first supporting mechanism is adapted to liftably support a portion on a bottom rail side of said framed panel, and said another portion of said framed panel is disposed so as to be located above the portion on the bottom rail side of said framed panel and to be located on the building interior side relative to the center of gravity of said framed panel in the opening portion fully-closed position.

8. A natural ventilation window comprising: a window frame which is installed in a building; a framed panel disposed in an opening portion defined by said window frame; and opening/closing means for opening and closing the opening portion on the basis of an air current,
said opening/closing means including a first supporting mechanism for supporting a portion on one side of either a top rail or a bottom rail of said framed panel liftably and rotatably about a horizontal axis and a second supporting mechanism for supporting another portion of said framed panel located below or above said portion, movably in a direction toward an interior or exterior of the building and rotatably about the horizontal axis,
said another portion of said framed panel being disposed so as to be located above a center of gravity of said framed panel and to be located on one side of either the building interior or the building exterior with respect to that center of gravity when said framed panel is in an opening portion closed position,
said second supporting mechanism including a supported member formed in said another portion of said framed panel and a support member which is fitted to said window frame so as to support said supported member,
said support member including a linear motion supporting portion for supporting said supported member linearly movably in the direction toward the interior or exterior of the building and rotatably about the horizontal axis and at least one of an end side supporting portion connected to an end portion close to a building interior side of said linear motion supporting portion and adapted to support said supported member movably in a direction intersecting to the direction toward the interior or exterior of the building and rotatably about the horizontal axis, so as to displace said another portion upward at the time of movement of said another portion of said framed panel in a direction toward the interior of the building, and to displace said another portion of said framed panel downward at the time of movement of said another portion in a direction toward the exterior of the building, and an end side supporting portion connected to an end portion close to a building exterior side of said linear motion supporting portion and adapted to support said supported member movably in the direction intersecting to the direction toward the interior or exterior of the building and rotatably about the horizontal axis, so as to displace said another portion of said framed panel downward at the time of movement of said another portion in the direction toward the interior of the building, and to displace said another portion of said framed panel upward at the time of movement of said another portion in the direction toward the exterior of the building.

9. The natural ventilation window according to claim 8, wherein said linear motion supporting portion and said end side supporting portion in cooperation with each other form an elongated hole or a slit for guiding said supported member in the direction toward the interior or exterior of the building and in the direction intersecting to the direction toward the interior or exterior of the building.

10. The natural ventilation window according to claim 8, wherein said first supporting mechanism is adapted to support the portion on one side of either the top rail or the bottom rail of said framed panel linearly movably in the vertical direction.

11. The natural ventilation window according to claim 8, wherein said another portion of said framed panel in an opening portion open position and the center of gravity of that framed panel are respectively located on an identical line extending in the vertical direction.

12. The natural ventilation window according to claim 8, wherein said opening/closing means has engaging means for causing said framed panel in the opening portion closed position to engage the window frame.

13. The natural ventilation window according to claim 8, wherein said first supporting mechanism is adapted to support a portion on the top rail side of said framed panel, and said second supporting mechanism is adapted to support said another portion of said framed panel so as to be located below the portion on the top rail side of said framed panel and to be located on the building exterior side with respect to the center of gravity of said framed panel in a case where said framed panel is in the opening portion closed position.

14. The natural ventilation window according to claim 8, wherein said first supporting mechanism is adapted to support a portion on the bottom rail side of said framed panel, and said second supporting mechanism is adapted to support said another portion of said framed panel so as to be located above the portion on the lower rail side of said framed panel and to be located on the building interior side with respect to the center of gravity of said framed panel in a case where said framed panel is in the opening portion closed position.

15. A natural ventilation window comprising: a window frame which is installed in a building; a framed panel disposed in an opening portion defined by said window frame; and opening/closing means for opening and closing the opening portion on the basis of an air current,
said opening/closing means including a first supporting mechanism for supporting a portion on a top rail side of said framed panel liftably and rotatably about a horizontal axis and a second supporting mechanism for supporting another portion of said framed panel located below said portion, movably in a direction toward an interior or exterior of the building and rotatably about the horizontal axis,
said another portion of said framed panel being disposed so as to be located above a center of gravity of said framed panel and to be located on a building exterior side with respect to that center of gravity when said framed panel is in an opening portion closed position,
said second supporting mechanism including: a supported member formed in said another portion of said framed panel; a support member for supporting said supported member linearly movably in the direction toward the interior or exterior of the building and rotatably about the horizontal axis; a rotating shaft for connecting said support member to said window frame rotatably about the horizontal axis so as to be located below and on a building interior side with respect to said supported member in a state of being supported by said support member linearly movably in the direction toward the interior or exterior of the building; a guide member which is fitted to said window frame and abuts against said supported member located close to the building interior side, so as to upwardly guide said supported member on the basis of the linear motion of said supported member in the direction toward the interior of the building and to downwardly guide said supported member on the basis of the linear motion of said supported member in the direction toward the exterior of the building; and a holding mechanism for holding an angle of rotation of the support member in a state of supporting said supported member linearly movably in the direction toward the interior or exterior of the building.

16. The natural ventilation window according to claim 15, wherein said support member includes: a linear motion supporting portion for supporting said supported member linearly movably in the direction toward the interior or exterior of the building and rotatably about the horizontal axis; and an end side supporting portion which is close to the building exterior side and is connected to an end portion close to the building exterior side of said linear motion supporting portion, said end side supporting portion being adapted to support said supported member movably in a direction intersecting to the direction toward the interior or exterior of the building and rotatably about the horizontal axis, so as to displace said another portion of said framed panel downward at the time of movement of said another portion in the direction toward the interior of the building, and to displace said another portion of said framed panel upward at the time of movement of said another portion in the direction toward the exterior of the building.

17. The natural ventilation window according to claim 16, wherein said linear motion supporting portion and said end side supporting portion in cooperation with each other form an elongated hole or a slit for guiding said supported member in the direction toward the interior or exterior of the building and in the direction intersecting to the direction toward the interior or exterior of the building.

18. The natural ventilation window according to claim 17, wherein said support member further includes an end side supporting portion which is close to the building interior side and is connected to an end portion close to the building interior side of said linear motion supporting portion, said end side supporting portion having a more enlarged portion of the elongated hole or the slit than a portion of the elongated hole or the slit formed in said linear motion supporting portion and being adapted to support said supported member in said enlarged portion.

19. The natural ventilation window according to claim 15, wherein said guide member is fitted to said window frame so as to abut against said supported member before or simultaneously as the rotation based on the linear motion of said supported member in the direction toward the interior of the building is generated in said support member.

20. The natural ventilation window according to claim 15, wherein said first supporting mechanism is adapted to support said portion on the top rail side of said framed panel linearly movably in a vertical direction.

21. The natural ventilation window according to claim 15, wherein said first supporting mechanism has an urging member for resiliently urging said portion on the top rail side of said framed panel downward with respect to said window frame, so as to impart a moving force in an opening portion opening direction to said framed panel.

22. The natural ventilation window according to claim 15, wherein said another portion of said framed panel in an opening portion open position and the center of gravity of that framed panel are respectively located on an identical line extending in the vertical direction.

23. The natural ventilation window according to claim 15, wherein said opening/closing means has engaging means for causing said framed panel in the opening portion closed position to engage the window frame.
